(19) United States
(12) Patent Application Publication
(10) Pub. No.: US 2010/0071381 A1
(43) Pub. Date: Mar. 25, 2010

(54) HIGH EFFICIENCY INTEGRATED GASIFICATION COMBINED CYCLE POWER PLANT

(76) Inventor: William S. Rollins, III, New Boston, NH (US)

Correspondence Address: MESMER & DELEAULT, PLLC, 1 NEW HAMPSHIRE AVE., SUITE 125, PORTSMOUTH, NH, 03801, US

(21) Appl. No.: 12/375,444

(22) PCT Filed: Jul. 27, 2007
(86) PCT No.: PCT/US07/74640

§ 371 Date: Oct. 14, 2009

Related U.S. Application Data
(60) Provisional application No. 60/820,754, filed on Jul. 28, 2006.

(51) Int. Cl. F02C 6/18; F02C 6/00

(52) U.S. Cl. 60/783; 60/784

(57) ABSTRACT

A system and method for integrating gasification processes with membrane oxygen separation, advanced steam conditions, and effective heat recovery. Through the integration of synergistic technologies, a highly efficient Integrated Gasification Combined Cycle (IGCC) power plant can be constructed. A combined cycle power plant that includes substantial amounts of duct firing in its Heat Recovery Steam Generator (HRSG) can be used in conjunction with membrane oxygen separation to provide the necessary air heating to the range of 1470 to 1650° F. This high-end energy in the HRSG can also be utilized to create more steam at elevated conditions in the HRSG, and thus provide additional cold feedwater for cooling in the HRSG and for cooling in both the gasification and oxygen membrane separation processes. When CO₂ release to atmosphere is to be minimized, the invention may utilize a synergistic hydrogen membrane separation technology.

### BACKGROUND

1. Field of Invention

The invention is the field of integrated gasification combined cycle (IGCC) power plants.

2. Description of the Related Art

As reserves of oil and natural gas dwindle, and the prices for these products escalate, industry and consumers will seek alternative energy options. In the power generation business in the U.S., and other areas of the world where it is abundant, coal is likely to become the fuel of choice due to its availability and price stability.

However, with increased environmental demands, especially with the emerging awareness of global warming, coal plants of the future must not only have low emissions of criteria pollutants such as nitrous oxides (NOₓ), sulfur oxides (SOₓ), and mercury, but must also implement methods to reduce and/or eliminate emissions of carbon dioxide (CO₂).

To help meet these objectives, the U.S. Department of Energy (DOE) has embarked upon a 20 year program to improve the efficiency of coal plants, reduce emissions, and implement technologies to remove and sequester CO₂. Highly efficient plants consume less coal than inefficient ones; so one way to reduce CO₂ emissions is to build more efficient coal plants. When these nominal reductions in CO₂ are insufficient, however, CO₂ removal and sequestration is required. Currently, technologies for the removal and sequestration of CO₂ emissions impose a 25 to 85% increase in the cost of electricity from the power plant.

Obviously, new technologies that can provide for a high efficiency coal plant and reduce or eliminate CO₂ emissions will be needed for the future. For more information, see the attached paper “High Efficiency Coal Plant that Meets the DOE 2020 Goals—One Decade Early”, by William S. Rollins, which is hereby incorporated by reference into this specification as if completely rewritten herein. This paper was presented at the 2007 Electric Power Conference in Chicago, Ill. in May 2007.

### PRIOR ART

Integrated Gasification Combined Cycle power plants are being offered by numerous companies, including GE, ConocoPhillips, Siemens, Shell, and others. These plants are all similar, utilizing a coal gasification process to generate fuel for a combined cycle power plant.

The gasification process begins by injecting pulverized coal into a pressure vessel called a “gasifier”. The coal can be injected in a dry condition, or mixed with water or another fluid and injected as a slurry. Oxygen (typically 95% pure) is also injected into the gasifier and in some instances, steam can also be injected. These reactants are injected in the correct proportions to create a synthesis gas (referred to as syngas) that consists of primarily carbon monoxide (CO) and hydrogen (H₂). This syngas may be initially cooled with a device known as a syngas cooler that produces high-pressure (HP) steam from the high temperature syngas. However, as the syngas temperatures decreases (nominally to 800° F.), no more HP steam can be produced. From this point, the various gasification processes call for syngas cooling by generating medium or low-pressure steam. For final cooling, typically a medium such as cooling water from the plant will be used to reject this low-grade heat.

Oxygen for the gasification process is typically provided by a cryogenic air separation unit (ASU). The ASU operates by compressing air, cooling it to very low temperatures (approx. −300° F.), and then essentially liquefying the oxygen. The heat from the intercoolers in the air compression process is typically rejected. The streams from this cryogenic process, a 95% pure oxygen stream, and a stream of mostly nitrogen, are delivered at relatively cold temperatures. A typical IGCC plant will produce about 750 MW of gross power, and the cryogenic ASU for this facility will consume approximately 100 MW of this gross power. With other parasitic loads, the nominal output for a conventional 2-on-1 IGCC facility with 2 large GT's is 630 MW.

Once the syngas is cooled, it is cleaned of most of the contaminants such as H₂S, NH₃, and others. It is then ready for supply to the power island. In most instances, the syngas fuel supply pressure from the clean up process is essentially the required pressure for the gas turbine (GT), so no fuel gas expanders are utilized. The syngas exits the clean up process at a nominal 100° F. Typical fuel temperatures into the GT are 300° to 400° F. after subsequent heating.

The power island in the IGCC plants of today employ one or more GT's, an HRSG for each GT, and a steam turbine (ST) to accept the steam from the HRSG(s). A typical GT, the GE Frame 7FB, requires about 1900 million Btu input with syngas fuel and needs approximately 450,000 lb/hr of diluent. This diluent consists of mostly nitrogen, with less than 2% oxygen. The diluent is injected into the GT combustion section to reduce the formation of nitrous oxides (NOₓ). Diluent temperatures into the GT are typically in the range of 200° to 400° F.

The HRSG's are of a multi-pressure level design, producing steam at two or more pressure levels with the HRSG. Duct burners are not provided as standard hardware in these HRSG's. If they are specified for non-standard applications, they are only to provide a small amount of additional power. The input energy to these occasional offerings of duct burners is less than 10% of the total input energy to the power island, and the duct burners may not be designed to use syngas, but another fuel such as natural gas. The stack temperature for these conventional HRSG's is in the range of 180 to 250° F.

The steam turbine (ST) is typically a reheat unit that is designed to accept not only high-pressure steam, but also steam at lower pressures from the HRSG's and the gasification process. Typical steam pressures are 1500 to 1800 psia inlet pressure, with inlet and reheat temperatures in the range of 950° to 1050° F.

These IGCC plants are nominally 38 to 42% efficient, based on the higher heating value (HHV) of the fuel (coal).

When carbon dioxide (CO₂) separation is required in an IGCC, for subsequent sequestration, the CO₂ is separated from the process and compressed to pipeline pressure, typically 2200 psia or higher. To separate a large portion of the CO₂ from the exhaust gas, most of the CO in the syngas fuel must be eliminated. This is typically accomplished through the use of the water-gas shift reaction. The water-gas shift requires that the syngas be moisturized to a prescribed level, so that the CO and H₂O in the syngas can be converted to CO₂ and H₂. This reaction is usually completed with the aid of catalysts.

Most IGCC plants are designed to use a sour gas shift, or perform the shift reaction before the syngas is completely cooled and has passed through the clean up process. This is typically simpler for the conventional IGCC, as there are higher temperatures available, and there is usually some water vapor already contained in the raw syngas. After the water-gas shift reaction, a great deal of water vapor remains in the syngas, and most of it is condensed out at lower temperatures, typically 150° to 350° F. This low-end energy is not very useful in a power plant.

After cooling, the syngas, comprised of mostly CO₂ and H₂, goes to the clean up process. Most of the CO₂ can be removed by various processes, and these processes may provide the CO₂ at lower pressures, requiring significant amounts of compression power to provide the CO₂ at pipeline pressures. Another separation process, Hydrogen Transport Membrane (HTM), can separate hydrogen while retaining the CO₂ at high pressure. However, the HTM process works most efficiently in the range of 650° to 900° F. With the conventional arrangement, it would be difficult to cool the syngas for the clean up process, and then reheat it to temperatures in excess of 650° F. Therefore, the HTM process is best if applied prior to the clean up process in the conventional IGCC in the prior art. This may introduce reliability issues, as the sulfur and other contaminants in the raw syngas may render the HTM membranes ineffective over time.

Also, to work effectively, HTM requires a pressure differential to separate the hydrogen. Essentially, the hydrogen on the upstream side of the HTM membranes will permeate the membrane until the partial pressure of hydrogen on the downstream side is equal to the partial pressure on the supply side, at which time there will be no more driving potential to separate additional hydrogen from the supply side. Therefore, low pressures on the downstream side of the membranes may be utilized to maximize the yield of hydrogen. However, this hydrogen must be compressed to the required fuel pressure for the gas turbine. Since hydrogen requires a great deal of energy to compress, this can be very inefficient.

In fact, studies by the Electric Power Research Institute (EPRI), indicate that the increase in coal consumption is nominally 25 to 35% more when CO₂ separation is implemented, and a commensurate increase in the cost of electricity is also expected.

### SUMMARY

By utilizing technologies such as ITM Oxygen, advanced steam conditions, and high density combined cycle technology, a highly efficient IGCC power plant can be designed and constructed. It also can be designed for ultra-low emissions as well. With the proper choice of equipment, this plant can be cost effective and can meet or exceed the U.S. DOE's year 2020 goals for power production from coal. Ultimately, this embodiment demonstrates a state-of-the-art facility that is 10 to 25% more efficient than conventional IGCC, can readily be designed for ultra-low emissions, and yet is economical to construct. For only an incremental increase in cost and fuel consumption, this invention can remove a major portion of the CO₂ from atmospheric discharge and provide it at pipeline pressure for sequestration. These and other benefits, features, and advantages will be made clearer in the accompanying description, claims, and drawings.

### DRAWINGS

FIG. 1 is a flow chart of the process of the present invention.

FIG. 2 is a report of calculated performance characteristics of the present invention.

FIG. 3 is a flow chart of the process of the present invention.

FIG. 4 is a report of calculated performance characteristics of the present invention.

FIG. 5 is a flow chart of the process of the present invention.

FIG. 6 is a report of calculated performance characteristics of the present invention.

### DESCRIPTION

### Introduction

A new, high efficiency Integrated Gasification Combined Cycle (IGCC) facility that meets the DOE 2020 Roadmap goals in its Clean Coal Power Initiative can be constructed by utilizing state-of-the-art technologies that demonstrate synergistic relationships. These new technologies will be commercial in the 2012 timeframe. A description of this IGCC facility, its features, and novel concepts, is described herein. This invention may use the high-density combined cycle power plants and power plant processes disclosed in U.S. Pat. Nos. 6,230,480; 6,494,045; 6,606,848; 6,792,759; and 7,131,259, invented by the inventor of this present invention, but which are not admitted to being prior art by their mention herein. In this specification and in the claims, they shall define a “high-density combined cycle power plant” and “high-density combined cycle power plant process.”

### Coal Preparation

This evaluation is based upon the use of Illinois #6 coal as fuel. Its ultimate analysis on an “as received” (AR) basis is listed in Table 1.

TABLE 1

| | Content |
|---|---|
| | % by |
| Constituent | Weight |
| H₂ | 5.80 |
| C | 59.70 |
| O₂ | 20.10 |
| N₂ | 1.00 |
| S | 3.80 |
| Ash | 9.60 |

Although this coal contains 14.4% moisture on an as received basis, it will be dried prior to use in the gasification process. The input for this plant will be 3000 tons per day (TPD) of coal on a dry basis. The heating value for this fuel as received is 10,810 Btu/lb HHV.

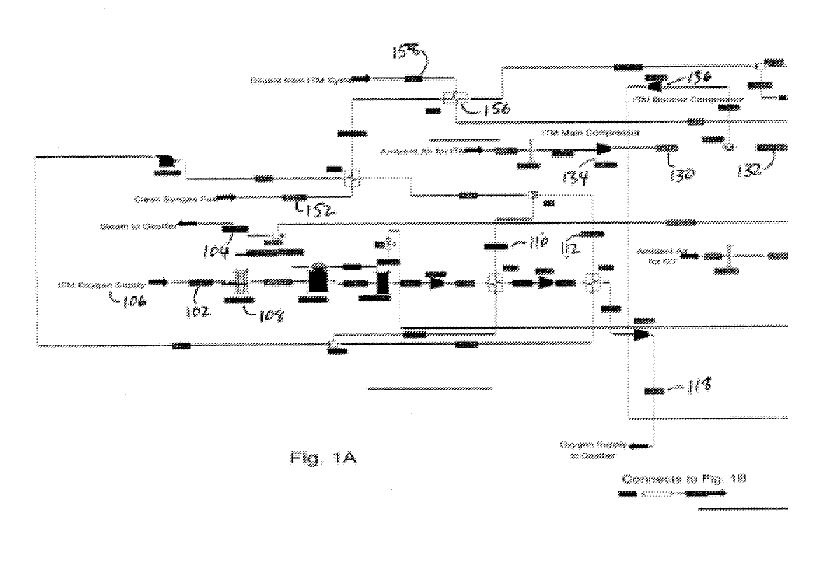

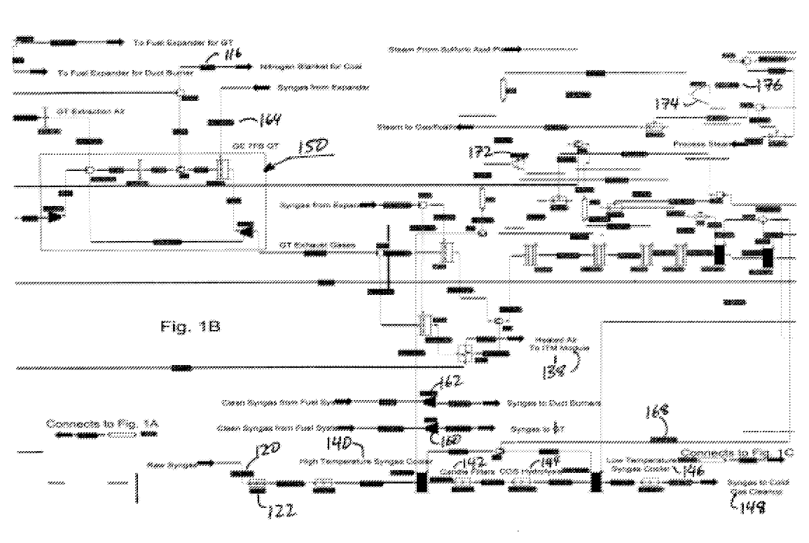

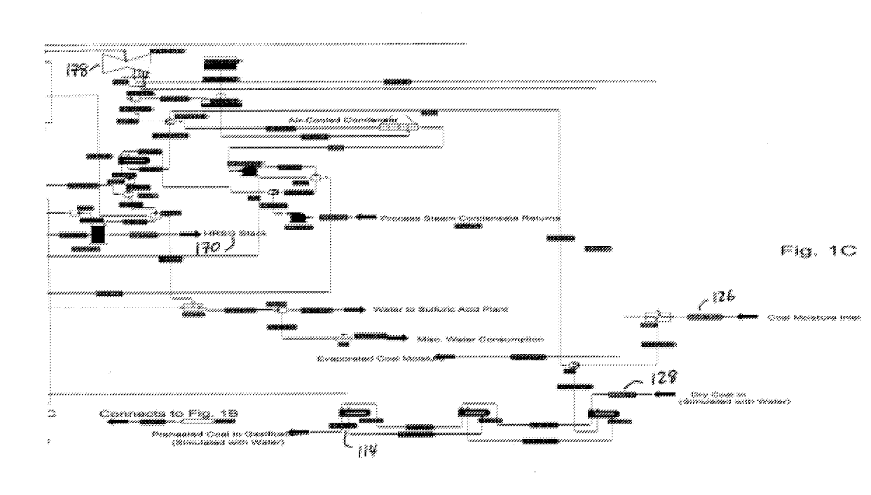

First, the coal is pulverized to the same size as would be utilized in a conventional pulverized coal plant, however, this sizing could be increased or decreased, depending upon the needs of the gasification system. The coal is then passed through a heater that heats the coal to approximately 220° F. This heating process heats the coal and drives off the moisture that is absorbed in the coal. For efficiency purposes, this heat is provided by low-pressure extraction steam from the steam turbine (ST), however, other process heat, waste energy, fuel, or electricity could be used to provide this heat. On the process schematic in FIG. 1 (note that by reference, FIG. 1 contains three sheets, FIGS. 1A, 1B, and 1C), the coal moisture that is removed is shown entering the heater as stream COALW1 126. This stream passes through a heat exchanger, is heated by the incoming steam from the ST, and is evaporated and vented to atmosphere. The condensed steam is returned to the condensate system.

For modeling purposes, the moisture in the coal is removed in a separate process from the coal preheating. In actuality, the coal will be preheated and dried in the single heating process to 220° F., however, due to limits on the GATECYCLE program, the software utilized to evaluate this process, the moisture is removed in one step, and the heating is accomplished in another. Therefore, in this model, after the coal is dried, it is still considered to be at its post grinding temperature of 100° F. From here it is then heated to 400° F. in three stages, each stage utilizing an amount of extraction steam from the ST (see COAL1 128 on the process diagram, FIG. 1, for this coal input). This preheated coal is sent to the gasification system for injection into the gasifier.

In this specification, it is understood that the drawings herein use standard drawing symbols whose meanings are well known in the art. Furthermore, lines drawn between apparatuses or processes are to be construed to mean that the apparatuses or processes are in communication with each other or are coupled with each other, for example, by a fluid conduit.

### ITM Oxygen

Since the gasification process requires oxygen to function, a system to provide oxygen is required. For cost, efficiency, and synergistic reasons, the ITM Oxygen process from Air Products and Chemicals, Inc. has been selected. The ITM process utilizes selective ceramic membranes that allow oxygen to permeate through its structure, while other gases will not. This provides a 99.2% pure oxygen supply downstream of the membranes (the remaining gas in this stream being 0.8% nitrogen). However, to properly function, the air into the membranes must be pressurized, and the supply temperature must be 1470 to 1650° F. A temperature of 1600° F. was utilized in this case.

Compressed air was supplied from both a dedicated main air compressor 134 and extraction air from the gas turbine (GT). These two air streams (ITMA3 130 and CDEXT2 132 on the process schematic, FIG. 1) are combined and sent to the ITM booster compressor, which compresses the air to 500 psia. This air is subsequently heated in the Heat Recovery Steam Generator (HRSG), just downstream of the duct burners. This heated air 138 at 1610° F. is supplied to the ITM separation modules. Table 3 provides the data for the ITM streams.

TABLE 3
475 MW
FutureCoal
Application

| | | |
|---|---|---|
| Total Air | 809804 | lb/hr |
| Flow | | |
| Total | 28067 | |
| Moles | | |

Air Supply

| Constituent | | Mole | Molecular | Flow | Flow |
|---|---|---|---|---|---|
| (Gas In) | Mol. Wt. | Fraction | Weight | lb/hr | moles |
| N2 | 28.020 | 0.7732 | 21.6651 | 608070 | 21701.3 |
| O2 | 32.000 | 0.2080 | 6.6560 | 186813 | 5837.9 |
| Ar | 39.940 | 0.0088 | 0.3515 | 9865 | 247.0 |
| H2O | 18.016 | 0.0100 | 0.1802 | 5057 | 280.7 |
| | | 1.0000 | 28.8527 | 809804 | 28067 |
| Constituent | | Mole | Molecular | Flow | Flow |
| (Gas Out) | Mol. Wt. | Fraction | Weight | lb/hr | moles |

Permeate
Side

| | | | | | |
|---|---|---|---|---|---|
| N2 | 28.020 | 0.0080 | 0.2242 | 1415 | 50.5 |
| O2 | 32.000 | 0.9920 | 31.7440 | 175406 | 5481.4 |
| Ar | 39.940 | 0.0000 | 0.0000 | 0 | 0.0 |
| H2O | 18.016 | 0.0000 | 0.0000 | 0 | 0.0 |
| | | 1.0000 | 31.9682 | 176821 | 5531.9 |

Non-
Permeate
Side

| | | | | | |
|---|---|---|---|---|---|
| N2 | 28.020 | 0.9608 | 26.9207 | 606655 | 21650.8 |
| O2 | 32.000 | 0.0158 | 0.5062 | 11407 | 356.5 |
| Ar | 39.940 | 0.0110 | 0.4378 | 9865 | 247.0 |
| H2O | 18.016 | 0.0125 | 0.2244 | 5057 | 280.7 |
| | | 1.0000 | 28.0890 | 632983 | 22535 |
| | | | | Flow | 809804 |
| | | | | Check | |

Although 500-psia pressure and 1610° F. are utilized in this example, other pressures and or temperatures that can meet the requirements of the membrane oxygen separation system can be employed in the preferred embodiment. In addition, the use of other gaseous streams that have oxygen content may be employed. One example of this gaseous stream is air that has been preheated in a direct combustion process. In this configuration, fuel is added to the air and combusted, resulting in a reduction of oxygen and the creation of products of combustion, which have been formed in the stream.

From the ITM modules, a stream of 99.2% pure oxygen 106 is supplied at 1600° F. to a heat recovery device 108 (stream O2S11 102 on the process schematic, FIG. 1). This device cools the oxygen stream and creates steam at 1800 psia, 1000° F. for the gasification reforming process (stream OHPS2 104). Note that it is also acceptable to produce this steam at lower temperatures or saturated conditions, and then send it to the superheaterz sections of the HRSG for further heating. After this heat recovery process, the oxygen is compressed to 1800 psia, 663° F., for supply to the gasifier. This oxygen compression process utilizes two intercoolers to reduce both the oxygen temperatures and the power of compression. The energy absorbed by these intercoolers (streams OW2B 110 and OW3B 112) is used to preheat the clean syngas fuel from the clean up process. Again, these pressures and temperatures are used as an example. This is not to preclude the use of other oxygen pressures, supply temperatures, intercooler arrangements, number of intercoolers, or other uses for the intercooler heat. In many compression systems, the heat from the intercoolers is typically rejected. This wastes the heat that is captured by the intercoolers, and increases the cost for the heat rejection equipment. The preferred embodiment demonstrates a system by which the oxygen can be efficiently compressed; yet still provide useful heat from the intercoolers to the IGCC process. This serves to increase the overall efficiency of the preferred embodiment of the present invention.

### Gasification

The gasification system consists of a gasifier vessel that accepts the reactants supplied by the system, and creates the raw syngas from a partial oxidation process. This process is designed to operate at 1500 psia in this example, however, other pressures, either higher or lower, can be utilized. Higher pressures are favorable for the following reasons:
1) Reduced volume flow for a given mass flow reduces size and cost
2) Some gas clean up processes, like Selexol, are more effective with higher pressures
3) When CO₂ removal is necessary, hydrogen separation membranes (HTM) yield better performance with higher pressures
4) Again, with CO₂ removal and HTM, the gases that do not permeate the HTM membranes are left at higher pressure, so less compression power is required to supply this CO₂ stream at pipeline pressure

The supply streams to the gasifier include COAL4 114, which is the dry, preheated coal to the gasifier (note that FIG. 1 indicates a flow of 75,000 lb/hr, due to the fact that this stream with the 250,000 lb/hr of coal and a heat capacity of 0.3 Btu/lb is equivalent to 75,000 lb/hr of water for the purposes of modeling extraction steam consumption). Also, stream DIL4 116 is a stream of inert gas (mostly nitrogen) supplied as a “blanket” over the coal to suppress any fire potential in the coal. Oxygen is also a reactant, which is supplied to the gasifier from stream O2F6 118. The final reactant is steam, which is supplied to the gasifier from stream OHPS2 104.

These reactants are converted in the gasification process from coal, oxygen, steam, and inert gases, into a synthesis gas (syngas) that is comprised of mainly CO and H₂, with some sulfur compounds, slag, and inert gases. The anticipated gasification process is defined in Table 2. Note here in Table 2 that 250,000 lb/hr of coal, the oxygen stream of 176,821 lb/hr, 25,000 lb/hr of CO₂, and 40,000 lb/hr of steam combine to produce 491,821 lb/hr of gasification products, of which 28,037 lb/hr is recovered as slag, while the remainder is raw syngas. The raw syngas composition is also included in Table 2. This gasification process is shown as an example. Other gasification processes can be utilized in the preferred embodiment of the present invention.

TABLE 2
475 MW
FutureCoal
Application

| | | | | Heat | Coal |
|---|---|---|---|---|---|
| | | | | Input | Flow |
| | | | Ratio | MMBtu | TPD |
| Illinois #6 | 12,810 | btu/lb | 0.10 | | |
| Coal Input | 250000 | lb/hr | | 3202.5 | 3000 |
| CO2 Fuel | 25000 | lb/hr | | | |
| Blanket | | | | | |

| Constituent | | | Flow | Flow |
|---|---|---|---|---|
| (Coal) | MW | % by Weight | lb/hr | moles |
| H2 | 2.016 | 4.89 | 12233.15516 | 6068.0 |
| C | 12.010 | 69.74 | 174357.4766 | 14517.7 |
| O2 | 32.000 | 8.54 | 21353.29344 | 667.3 |
| N2 | 28.020 | 1.17 | 2920.560748 | 104.2 |
| Sulfur | 32.066 | 4.44 | 11098.13084 | 346.1 |
| Ash | | 11.21 | 28037.38318 | 0.0 |
| Ar | 39.940 | 0.00 | 0.0E+01 | 0.0 |
| | | 100.0 | 250000 | 21703.3 |

ITM Oxygen
Supply

| | |
|---|---|
| ITM Flow | 176821 lb/hr |

| Constituent | Mol. | Mole | Molecular | Flow | Flow | | |
|---|---|---|---|---|---|---|---|
| (Gas In) | Wt. | Fraction | Weight | lb/hr | moles | | |
| N2 | 28.020 | 0.0080 | 0.2242 | 1415 | 50.5 | | |
| O2 | 32.000 | 0.9920 | 31.7440 | 175406 | 5481.4 | 5481.4 | 0.0 |
| Ar | 39.940 | 0.0000 | 0.0000 | 0 | 0.0 | | |
| H2O | 18.016 | 0.0000 | 0.0000 | 0 | 0.0 | | |
| | | 1.0000 | 31.9682 | 176821 | 5531.9 | | |

Steam
Supply

| | |
|---|---|
| Steam | 40000 lb/hr |
| Flow | |

| Constituent | Mol. | Mole | Molecular | Flow | Flow |
|---|---|---|---|---|---|
| (Gas In) | Wt. | Fraction | Weight | lb/hr | moles |
| H2 | 2.016 | 0.6667 | 1.3441 | 4477 | 2220.5 |
| O2 | 32.000 | 0.3333 | 10.6656 | 35523 | 1110.1 |
| | 1.0000 | 12.0097 | 40000 | 3330.7 | |

| | |
|---|---|
| Total Mass | 491821 lb/hr |
| Input to | |
| Gasifier | |
| Slag | 28037 lb/hr |
| Total Gas | 463783 lb/hr |
| Output | |
| from | |
| Gasifier | |

Raw Syngas
Composition

| | | | | | | | Flow | |
|---|---|---|---|---|---|---|---|---|
| | | | | | | | from | Reaction |
| Constituent | Mol. | Mole | Molecular | Flow | Flow | Hf, | gasifier | Heat, |
| (Gas Out) | Wt. | Fraction | Weight | lb/hr | moles | LHV | lb/hr | MMBtu |
| H2 | 2.016 | 0.3381 | 0.6817 | 16040 | 7956.3 | | | |
| CH4 | 16.040 | 0.0000 | 0.0000 | 0 | 0.0 | 21515 | 0 | 0.0 |
| CO | 28.010 | 0.6164 | 17.2660 | 406253 | 14503.8 | −3960 | 174191 | −689.8 |
| CO2 | 44.010 | 0.0241 | 1.0625 | 25000 | 568.1 | −14096 | 0.0E+01 | 0.0 |
| H2O | 18.016 | 0.0000 | 0.0000 | 0 | 0.0 | 51590 | 4476 | 230.9 |
| N2 | 28.020 | 0.0066 | 0.1842 | 4335 | 154.7 | | | |
| Ar | 39.940 | 0.0000 | 0.0000 | 0 | 0.0 | | | |
| H2S | 34.082 | 0.0141 | 0.4813 | 11324 | 332.3 | −4322 | 165 | −0.7 |
| COS | 60.076 | 0.0006 | 0.0353 | 832 | 13.8 | | | |
| | | 1.0000 | 19.7111 | 463783.6 | 23529.0 | | | −459.6 |

Also from Table 2, the calculated energy release by this gasification process is 459.6 million Btu/hr. The products of the reaction will absorb this energy. Also, since the reactants are preheated, an additional 101.7 million Btu/hr was added to the reactants by this preheating function. This preheat energy, along with the calculated heat of reaction is added to the syngas stream to model the final temperature of the syngas as it leaves the gasifier.

See stream SYNG1 120, which is the raw syngas, at its normal inlet temperature of 100° F. With the energy from preheat added in device FPT1 122, the raw syngas temperature is increased by the 101.7 million Btu/hr input to 702° F. This stream continues to device GASF1 124, which adds the heat of reaction to the stream. This now exemplifies the syngas, including the preheat and reaction energy addition, as it would exit the gasifier.

### Raw Syngas Cooling/Heat Recovery

This raw syngas that exits the gasifier is first sent to an initial stage solids removal process. This would include a water-cooled slag chamber with water filled tubes, and would continue to a water-cooled cyclone separator. The molten slag from the gasification process deposits onto these “cold” surfaces and solidifies. After an initial layer of deposits is formed, the surface temperatures increase (due to insulation effect of solidified slag on the aforementioned “cold” surfaces). This inhibits further depositions on these surfaces, thus forming a slag barrier, much like in other gasifiers, to protect the metal surfaces in the slag chamber from the molten slag.

After the slag chamber, the gases would then travel to a separate section, likely to be at a higher elevation than the slag chamber, such that the heavy slag particulate would not be carried over with the raw syngas beyond the slag chamber. This separate section would include a water-cooled cyclone separator. This device would serve to remove some of the lighter particulate such as fly ash or unreacted carbon. Note that neither the slag chamber nor the water-cooled cyclone separator areas are shown in FIG. 1. From here, the raw syngas would continue to the syngas cooler.

The high temperature syngas cooler 140 reduces the raw syngas from a nominal 3000° F. to approximately 430° F. These temperatures can be varied, but are used here for example. After exiting the high temperature syngas cooler, the raw syngas can be passed through a set of candle filters 142. These devices remove 99.99% of the particulate matter through the use of sintered metal filters. Other methods of particulate removal are acceptable, but the candle filters 142 are mentioned due to their high level of effectiveness. From here, the raw syngas can be sent to a COS hydrolysis unit 144 which converts a high percentage of the COS in the raw syngas to CO₂ and H₂. Water vapor may be injected into the raw syngas, and is partially consumed in this reaction.

From the COS hydrolysis unit 144, the raw syngas is sent to the low temperature syngas cooler 146 which reduces the temperature of the raw syngas to a nominal 100° F. This raw syngas 148 is now suitable for use in a cold gas clean up system. Note that all of the raw syngas energy has been recovered, and it has been recovered in a very efficient manner, by using feedwater that will be converted into high-pressure (HP) steam for power generation. This is in contrast to existing gasification processes that either make an intermediate or low pressure steam with some of the syngas energy, and/or simply waste it by sending it to the power plant's heat rejection equipment. Recovering this energy from the syngas and utilizing it in the feedwater/steam system provides increased efficiency in the preferred embodiment of the present invention.

For a complete listing of stream data for FIG. 1, see Tables 4, 5, 6, and 7. These tables include pressure in psia, temperature in degrees F., flow in lb/hr, and enthalpy in Btu/lb for each stream. The streams as labeled in FIG. 1, correspond with the data in Tables 4 thru 7.

TABLE 4

| | | | Temperature | Pressure | Flow | Enthalpy | |
|---|---|---|---|---|---|---|---|
| Stream | From | To | Degrees F. | psia | lb/hr | btu/lb | Quality |
| AIR1 | — | DUCT1 | 58.99998856 | 14.43239689 | 3554000 | −0.241509497 | 4 |
| AIR2 | DUCT1 | 7FBC1 | 58.99998856 | 14.32439709 | 3554000 | −0.241509497 | 4 |
| AIRA2 | HX1 | — | 1610 | 490 | 809800 | 402.6252747 | 4 |
| CD1 | 7FBC1 | 7FBSP1 | 820.1157227 | 257.8391418 | 3554000 | 188.8095856 | 4 |
| CD2 | 7FBSP1 | 7FBD2 | 820.1157227 | 257.8391418 | 2940054.25 | 188.8095856 | 4 |
| CD3 | 7FBD2 | M1 | 820.114502 | 214.0065002 | 2940054.25 | 188.8095856 | 4 |
| CD4 | M1 | GTB3 | 851.519165 | 214.0065002 | 3548213.5 | 197.5370026 | 4 |
| CDEXT1 | 7FBSP1 | DUCT2 | 820.1157227 | 257.8391418 | 112000 | 188.8095856 | 4 |
| CDEXT2 | DUCT2 | ITMM1 | 820.114502 | 238.5012054 | 112000 | 188.8095856 | 4 |
| CHXDR1 | HX6 | M7 | 185.0471802 | 35 | 37000 | 153.1257019 | 0.0E+01 |
| CMIX2 | SP14 | SP9 | 175.053894 | 4803.537598 | 6600.547363 | 154.3620148 | 0.0E+01 |
| CMIX3 | SP9 | TMX2 | 175.053894 | 4803.537598 | 6600.547363 | 154.3620148 | 0.0E+01 |
| CMIX4 | SP9 | TMX5 | 175.053894 | 4803.537598 | 0.0E+01 | 154.3620148 | 0.0E+01 |
| COAL1 | — | FWH2 | 100.000145 | 600 | 75000 | 69.57876587 | 0.0E+01 |
| COAL2 | FWH2 | FWH3 | 214.6862488 | 600 | 75000 | 184.1669464 | 0.0E+01 |
| COAL3 | FWH3 | FWH4 | 305.9277039 | 600 | 75000 | 276.7874146 | 0.0E+01 |
| COAL4 | FWH4 | — | 401.7137146 | 600 | 75000 | 377.3396301 | 0.0E+01 |
| COALW1 | — | HX6 | 100.0000305 | 14.70000267 | 36000 | 68.03512573 | 0.0E+01 |
| COALW2 | HX6 | — | 213.0142517 | 14.70000267 | 36000 | 1150.959351 | 1 |
| COND1 | MIXFHO | AC1 | 86.88021088 | 0.632653058 | 1356147.5 | 882.404541 | 0.792237759 |
| CONDIN | SPLDA | MIXFHO | 86.88021088 | 0.632653058 | 1210532.5 | 977.0914917 | 0.882889748 |
| CRET1 | — | CNDR1 | 266 | 60 | 58950.03906 | 234.9108429 | 0.0E+01 |
| CRET2 | CNDR1 | M4 | 274.0155029 | 4803.537598 | 58950.03906 | 252.6100922 | 0.0E+01 |
| CRH1 | M6 | PI2 | 734.1380615 | 1100 | 1414696 | 1342.377075 | 1 |
| CRH1B | PI2 | RHT1 | 731.1014404 | 1083.5 | 1414696 | 1341.377075 | 1 |
| CRH2 | RHT1 | TMX3 | 974.9998779 | 1071.5 | 1414696 | 1489.006348 | 1 |
| CRH3 | TMX3 | RHT2 | 974.9998779 | 1071.5 | 1414696 | 1489.006348 | 1 |
| CRHA | HPST | M6 | 747.8873291 | 1100 | 1332000.125 | 1351.501587 | 1 |
| DASTM | SPLDA | DEAER | 86.88021088 | 0.632653058 | 424.0147095 | 977.0914917 | 0.882889748 |
| DBFL2 | SP3 | DB1 | 215.6552429 | 50 | 53912.97266 | 55.99117279 | 0.0E+01 |
| DBFL2A | SP3 | DB2 | 215.6552429 | 50 | 85044.52344 | 55.99117279 | 0.0E+01 |
| DBGAS1 | — | SP3 | 215.6552429 | 50 | 138957.4844 | 55.99117279 | 0.0E+01 |
| DIL1 | — | HX4 | 1600 | 460 | 633159.25 | 405.8459778 | 0.0E+01 |
| DIL2 | HX4 | SP15 | 1000.000061 | 460 | 633159.25 | 239.7684631 | 0.0E+01 |
| DIL3 | SP15 | M1 | 1000.000061 | 460 | 608159.1875 | 239.7684631 | 0.0E+01 |
| DIL4 | SP15 | — | 1000.000061 | 460 | 25000 | 239.7684631 | 0.0E+01 |
| EXP1 | — | EXP2 | 934.7421265 | 1250 | 138957.4844 | 323.9877319 | 0.0E+01 |
| EXP1A | EXP2 | — | 215.6552429 | 50.00000381 | 138957.4844 | 55.99337006 | 0.0E+01 |
| EXT1 | SP5 | TMX2 | 545.0579224 | 90.00000763 | 58124.44922 | 1302.892578 | 1 |
| EXT2 | CONDST | FWH1 | 182.8581543 | 8 | 89637.35938 | 1110.063477 | 0.970404327 |
| EXTC1 | CONDST | HX6 | 359.4873657 | 35 | 37000 | 1217.318481 | 1 |
| EXTC2 | CONDST | FWH2 | 260.2702942 | 20 | 6628.557129 | 1172.150391 | 1 |
| EXTC3 | SP5 | FWH3 | 545.0579224 | 90.00000763 | 5762.380371 | 1302.892578 | 1 |
| EXTC4 | IPST | FWH4 | 839.4290161 | 300 | 6586.742676 | 1441.87854 | 1 |

TABLE 5

| | | | Temperature | Pressure | Flow | Enthalpy | |
|---|---|---|---|---|---|---|---|
| Stream | From | To | Degrees F. | psia | lb/hr | btu/lb | Quality |
| FEXP1 | SP12 | — | 934.7421265 | 1250 | 138957.4844 | 323.9847107 | 0.0E+01 |
| FHMIXI | DEAER | AC1 | 86.88021088 | 0.632653058 | 57399.02734 | 54.90411377 | 0.0E+01 |
| FUEL1 | — | HX3 | 99.99997711 | 1250 | 451865 | 14.34887981 | 0.0E+01 |
| FUELA1 | SP12 | — | 934.7421265 | 1250 | 312907.5 | 323.9847107 | 0.0E+01 |
| FUELA2 | — | EX1 | 934.7421265 | 1250 | 312907.5 | 323.9877319 | 0.0E+01 |
| FUELA3 | EX1 | — | 651.7988892 | 470.0000305 | 312907.5 | 216.352417 | 0.0E+01 |
| FUELA4 | — | GTB3 | 651.7988892 | 460 | 312907.5 | 216.2289581 | 0.0E+01 |
| FUELS1 | HX3 | HX4 | 319.2948303 | 1250 | 451865 | 93.5787735 | 0.0E+01 |
| FUELS2 | HX4 | SP12 | 934.7421265 | 1250 | 451865 | 323.9847107 | 0.0E+01 |
| FW1B | SP10 | SP14 | 175.053894 | 4803.537598 | 1215800.5 | 154.3620148 | 0.0E+01 |
| FW1D | SP14 | ECON1 | 175.053894 | 4803.537598 | 1169871.5 | 154.3620148 | 0.0E+01 |
| FW2A | ECON1 | SP6 | 266.5263367 | 4787.537598 | 1169871.5 | 245.0859528 | 0.0E+01 |
| FW2B | SP6 | ECON2 | 266.5263367 | 4787.537598 | 1169871.5 | 245.0859528 | 0.0E+01 |
| FW3 | ECON2 | SP7 | 390.9481506 | 4732.537598 | 1169871.5 | 371.4335632 | 0.0E+01 |
| FW3A | SP7 | ECON3 | 390.9481506 | 4732.537598 | 911940.6875 | 371.4335632 | 0.0E+01 |
| FWC1 | CNDPMP | SP8 | 88.10744476 | 5200.000977 | 1413546.5 | 69.96542358 | 0.0E+01 |
| FWC1A | SP8 | M4 | 88.10744476 | 5200.000977 | 1156850.5 | 69.96542358 | 0.0E+01 |
| FWC2 | M4 | FWH1 | 98.21442413 | 4803.537598 | 1215800.5 | 78.82125092 | 0.0E+01 |
| FWC3 | FWH1 | SP4 | 175.053894 | 4803.537598 | 1215800.5 | 154.3620148 | 0.0E+01 |
| FWC4 | SP4 | SP10 | 175.053894 | 4803.537598 | 1215800.5 | 154.3620148 | 0.0E+01 |
| FWD2 | SCOOL2 | M9 | 354.5844421 | 5200.000977 | 210000 | 334.754425 | 0.0E+01 |
| FWD3 | M9 | ECON4 | 373.2136841 | 4732.537598 | 420000 | 353.0939636 | 0.0E+01 |
| FWH1DR | FWH1 | MIXFHO | 107.2144241 | 7.519999981 | 89637.35938 | 75.21679688 | 0.0E+01 |
| FWH2DR | FWH2 | M7 | 109.000145 | 18.80000114 | 18977.67969 | 77.02861786 | 0.0E+01 |
| FWH3DR | FWH3 | FWH2 | 223.6862488 | 84.6000061 | 12349.12207 | 192.0957336 | 0.0E+01 |
| FWH4DR | FWH4 | FWH3 | 314.9277039 | 282 | 6586.742676 | 285.4906006 | 0.0E+01 |
| GSTM1 | HPST | TMX5 | 885.8250732 | 1800 | 0.0E+01 | 1407.658691 | 1 |
| GT3X7 | ECON3 | ECON2 | 413.6437683 | 14.70460033 | 4502024.5 | 88.05561829 | 4 |
| GTEX1 | TEX1 | SP1 | 1102.480347 | 14.93999958 | 4363066.5 | 269.8434753 | 4 |
| GTEX2A | SP1 | DB1 | 1102.480347 | 14.93999958 | 2181533.25 | 269.8434143 | 4 |
| GTEX2B | SP1 | DB2 | 1102.480347 | 14.93999958 | 2181533.25 | 269.8434143 | 4 |
| GTEX3 | M5 | RHT2 | 1599.7948 | 14.90399933 | 4502024.5 | 415.3993225 | 4 |
| GTEX3A | DB1 | M5 | 1558.554932 | 14.90399933 | 2235446.5 | 402.372406 | 4 |
| GTEX3B | DB2 | HX1 | 1800.026123 | 14.93999958 | 2266577.75 | 476.028656 | 4 |
| GTEX4 | RHT2 | SPHT1 | 1458.985596 | 14.8569994 | 4502024.5 | 374.1274719 | 4 |
| GTEX4B | HX1 | M5 | 1640.092896 | 14.93999958 | 2266577.75 | 428.2477417 | 4 |
| GTEX5 | SPHT1 | RHT1 | 1368.619385 | 14.80599976 | 4502024.5 | 347.9306946 | 4 |
| GTEX6 | RHT1 | SPHT2 | 1204.861572 | 14.78399944 | 4502024.5 | 301.076416 | 4 |
| GTEX6A | SPHT2 | ECON3 | 793.0393677 | 14.70460033 | 4502024.5 | 187.2986145 | 4 |
| GTEX8 | ECON2 | ECON1 | 282.4925537 | 14.62519932 | 4502024.5 | 54.96525192 | 4 |
| GXTM2 | TMX5 | — | 885.8250732 | 1800 | 0.0E+01 | 1407.658691 | 1 |
| HEAT | TMX2 | — | 319.8912354 | 87 | 64724.99609 | 1185.767334 | 1 |
| HG1 | GTB3 | TEX1 | 2419.253906 | 214.0065002 | 3861121 | 659.2246094 | 4 |

TABLE 6

| | | | Temperature | Pressure | Flow | Enthalpy | |
|---|---|---|---|---|---|---|---|
| Stream | From | To | Degrees F. | psia | lb/hr | btu/lb | Quality |
| HPATT1 | SP10 | SP2 | 175.053894 | 4803.537598 | 0.0E+01 | 154.3620148 | 0.0E+01 |
| HPATT2 | SP2 | TMX1 | 175.053894 | 4803.537598 | 0.0E+01 | 154.3620148 | 0.0E+01 |
| HPATT3 | SP2 | TMX3 | 175.053894 | 4803.537598 | 0.0E+01 | 154.3620148 | 0.0E+01 |
| HPS1 | V2 | SPHT2 | 745.7628784 | 4732.537598 | 911940.6875 | 857.0715332 | 1 |
| HPS2 | SPHT2 | TMX1 | 1040.000122 | 4661.537598 | 911940.6875 | 1413.250366 | 1 |
| HPS2A | TMX1 | SPHT1 | 1040.000122 | 4661.537598 | 912000 | 1413.250366 | 1 |
| HPS3 | SPHT1 | M3 | 1202.996338 | 4568.537598 | 912000 | 1541.288574 | 1 |
| HPS3A | M3 | PI1 | 1179.738281 | 4568.537598 | 1332000.125 | 1524.53479 | 1 |
| HPS4 | PI1 | HPST | 1176.068481 | 4500.009766 | 1332000.125 | 1523.534668 | 1 |
| HPSSY1 | ECON4 | M3 | 1131.115356 | 4590.561523 | 420000 | 1488.024536 | 1 |
| HRH1 | RHT2 | PI3 | 1203.025635 | 1051.5 | 1414696 | 1619.046265 | 1 |
| HRH2 | PI3 | IPST | 1200.674561 | 1035.727539 | 1414696 | 1618.046143 | 1 |
| HS1 | ECON3 | V2 | 745.5881958 | 4732.537598 | 911940.6875 | 856.4891357 | 1 |
| HTDR1 | M7 | MIXFHO | 159.3360291 | 18.80000114 | 55977.67578 | 127.3271027 | 0.0E+01 |
| IPATT | SP14 | TMX4 | 175.053894 | 4803.537598 | 39328.33594 | 154.3620148 | 0.0E+01 |
| IPBFW1 | SP7 | TMX4 | 390.9481506 | 4732.537598 | 47871.71484 | 371.4335632 | 0.0E+01 |
| IPBFW2 | TMX4 | SP11 | 301.8562317 | 1100 | 87200.05469 | 273.5314941 | 0.0E+01 |
| IPBFW3 | SP11 | — | 301.8562317 | 1100 | 76000 | 273.5314941 | 0.0E+01 |
| IPSTM1 | — | M6 | 565 | 1100 | 76000 | 1199.793945 | 1 |
| ITMA1 | — | ITMD2 | 58.99998856 | 14.43239689 | 697800 | −0.241509497 | 4 |
| ITMA2 | ITMD2 | ITMC1 | 58.99998856 | 14.32439709 | 697800 | −0.241509497 | 4 |
| ITMA3 | ITMC1 | ITMM1 | 805.5056763 | 239.9999847 | 697800 | 185.0277557 | 4 |
| ITMA4 | ITMM1 | ITMC2 | 807.5948486 | 238.5012054 | 809800 | 185.5681 | 4 |
| ITMA5 | ITMC2 | HX1 | 1128.553345 | 499.9999695 | 809800 | 270.213623 | 4 |
| LPBFW | SP11 | V1 | 301.8562317 | 1100 | 11200.04688 | 273.5314941 | 0.0E+01 |
| LPBFW2 | V1 | — | 303.4197998 | 230 | 11200.04688 | 273.5314941 | 0.0E+01 |
| MAKWAT | MAKEUP | DEAER | 80.00002289 | 2.175565243 | 56975.01563 | 48.04108429 | 0.0E+01 |
| NCOOL1 | 7FBSP1 | TEX1 | 820.1157227 | 257.8391418 | 501945.7188 | 188.8095856 | 4 |
| O2CL1 | SP8 | SCOOL2 | 88.10744476 | 5200.000977 | 210000 | 69.96542358 | 0.0E+01 |
| O2F1 | ECONO1 | O2C2 | 125.7118835 | 4.800000191 | 176645 | 14.44906998 | 0.0E+01 |
| O2F2 | O2C2 | HX5 | 579.998291 | 33.60000229 | 176645 | 118.5128937 | 0.0E+01 |
| O2F3 | HX5 | 02C3 | 147.7777557 | 32.9280014 | 176645 | 19.32868576 | 0.0E+01 |
| O2F4 | 02C3 | HX2 | 616.4000854 | 230.4960022 | 176645 | 127.2039185 | 0.0E+01 |
| O2F5 | HX2 | O2C3 | 149.7421112 | 230.4960022 | 176645 | 19.76324272 | 0.0E+01 |
| O2F6 | O2C3 | — | 663.5941772 | 1800 | 176645 | 138.5484619 | 0.0E+01 |
| O2S11 | — | SPHTO1 | 1600 | 4.800000191 | 176645 | 377.4942017 | 0.0E+01 |
| O2S12 | EVAPO2 | ECONO1 | 648.5640869 | 4.800000191 | 176645 | 134.9262085 | 0.0E+01 |
| O2S12A | SPHTO1 | EVAPO2 | 1311.377563 | 4.800000191 | 176645 | 301.6317139 | 0.0E+01 |
| OHPS1 | EVAPO2 | SP16 | 628.5641479 | 1900 | 46695.91797 | 1145.586182 | 1 |
| OHPS1A | SP16 | SPHTO1 | 628.5641479 | 1900 | 40000 | 1145.586182 | 1 |
| OHPS1B | SP16 | M6 | 628.5641479 | 1900 | 6695.91748 | 1145.586182 | 1 |
| OHPS2 | SPHTO1 | — | 999.9943237 | 1900 | 40000 | 1477.369019 | 1 |

TABLE 7

| | | | Temperature | Pressure | Flow | Enthalpy | |
|---|---|---|---|---|---|---|---|
| Stream | From | To | Degrees F. | psia | lb/hr | btu/lb | Quality |
| OW1 | SP8 | V3 | 88.10744476 | 5200.000977 | 46695.91797 | 69.96542358 | 0.0E+01 |
| OW1A | V3 | ECONO1 | 96.93990326 | 1900 | 46695.91797 | 69.96542358 | 0.0E+01 |
| OW2 | ECONO1 | EVAPO2 | 528.4664917 | 1900 | 46695.91797 | 521.2033691 | 0.0E+01 |
| OW2A | SP13 | HX5 | 124.1688004 | 1800 | 40000 | 96.69525146 | 0.0E+01 |
| OW2B | HX5 | M2 | 535.8710938 | 1764 | 40000 | 530.3683472 | 0.0E+01 |
| OW3A | SP13 | HX2 | 124.1688004 | 1800 | 40000 | 96.69525146 | 0.0E+01 |
| OW3B | HX2 | M2 | 564.4648438 | 1800 | 40000 | 566.4688721 | 0.0E+01 |
| OW4 | M2 | HX3 | 550.3560791 | 1764 | 80000 | 548.4186401 | 0.0E+01 |
| OW5 | HX3 | PUMP1 | 123.9916992 | 1764 | 80000 | 96.42827606 | 0.0E+01 |
| OW6 | PUMP1 | SP13 | 124.1688004 | 1800 | 80000 | 96.69525146 | 0.0E+01 |
| S33 | AC1 | CNDPMP | 84.35214996 | 0.620000005 | 1413546.5 | 52.38088989 | 0.0E+01 |
| S34 | CONDST | SPLDA | 86.88021088 | 0.632653058 | 1210956.375 | 977.0914917 | 0.882889748 |
| STACK | ECON1 | — | 186.8853455 | 14.53119946 | 4502024.5 | 31.18561935 | 4 |
| STSYN1 | SP7 | M9 | 390.9481506 | 4732.537598 | 210000 | 371.4335632 | 0.0E+01 |
| SYNG1 | — | FPT1 | 99.99997711 | 1500.000122 | 463784.3438 | 14.22437954 | 0.0E+01 |
| SYNG1B | FPT1 | GASF1 | 702.2905273 | 1500.000122 | 463784.3438 | 233.507309 | 0.0E+01 |
| SYNG2 | GASF1 | ECON4 | 2980.731201 | 1500.000122 | 463784.3438 | 1171.549561 | 0.0E+01 |
| SYNG3 | ECON4 | CDLFIL | 431.4731445 | 1395.000122 | 463784.3438 | 133.4861603 | 0.0E+01 |
| SYNG4 | CDLFIL | COSHYD | 431.6717834 | 1395.000122 | 463784.3438 | 133.5585632 | 0.0E+01 |
| SYNG5 | COSHYD | SCOOL2 | 431.6717834 | 1395.000122 | 463784.3438 | 133.5585327 | 0.0E+01 |
| SYNG6 | SCOOL2 | SELEX1 | 95.05360413 | 1297.350098 | 463784.3438 | 12.46401596 | 0.0E+01 |
| SYNG7 | SELEX1 | — | 95.05360413 | 1297.350098 | 463784.3438 | 12.46401596 | 0.0E+01 |
| XOVER | IPST | SP5 | 545.0579224 | 90.00000763 | 1408109.125 | 1302.892578 | 1 |
| XOVERB | SP5 | CONDST | 545.0579224 | 90.00000763 | 1344222.25 | 1302.892578 | 1 |

### Cold Gas Clean Up

The raw syngas 148 in this example exits the low temperature section of the syngas cooler 146 at a nominal 100° F., 1350 psia. At 100° F., the saturation pressure of water is only 0.95 psia; therefore, the 1350 psia syngas has a water content of only 0.07% after it exits the syngas cooler. This relatively dry syngas is then cleaned in a conventional cold gas clean up system. SELEXOL is utilized to reduce to the total sulfur content (H₂S plus COS) to 5 ppm. Due to the nature of its operation, SELEXOL is more effective for sulfur removal with higher syngas pressures. Once the syngas exits the SELEXOL system, almost all of the H₂S, COS, HCN, and NH₃ has been removed. Also, greater than 99.8% of the sulfur has been removed. Table 8 provides the data for the raw syngas from the gasifier, and its composition upon exit from the cold gas clean up process.

Again, the process for cold gas clean up is shown as an example. However, other clean up processes, including Amine, Rectisol, or others may be utilized.

TABLE 8

| | | | | | |
|---|---|---|---|---|---|
| Constituent | | Mole | Molecular | Flow | Flow |
| (Gas Out) | Mol. Wt. | Fraction | Weight | lb/hr | moles |

Raw Syngas

| | | | | | |
|---|---|---|---|---|---|
| H2 | 2.016 | 0.3381 | 0.6814 | 16040 | 7956.3 |
| CH4 | 16.04 | 0.0000 | 0.0000 | 0 | 0.0 |
| CO | 28.01 | 0.6164 | 17.2581 | 406253 | 14503.8 |
| CO2 | 44.01 | 0.0241 | 1.0620 | 25000 | 568.1 |
| H2O | 18.016 | 0.0000 | 0.0000 | 0 | 0.0 |
| N2 | 28.02 | 0.0066 | 0.1918 | 4335 | 154.7 |
| Ar | 39.94 | 0.0000 | 0.0075 | 0 | 0.0 |
| H2S | 34.082 | 0.0141 | 0.4811 | 11324 | 332.3 |
| COS | 60.076 | 0.0006 | 0.0353 | 832 | 13.8 |
| | | 1.000 | 19.71719542 | 463784 | 23529.03755 |

Syngas after Cold Gas Clean Up

| | | | | | |
|---|---|---|---|---|---|
| H2 | 2.016 | 0.34301 | 0.6915 | 16040 | 7956.3 |
| CH4 | 16.04 | 0.00000 | 0.0000 | 0 | 0.0 |
| CO | 28.01 | 0.62528 | 17.5140 | 406253 | 14503.8 |
| CO2 | 44.01 | 0.02449 | 1.0778 | 25000 | 568.1 |
| H2O | 18.016 | 0.00055 | 0.0099 | 230 | 12.8 |
| N2 | 28.02 | 0.00667 | 0.1869 | 4335 | 154.7 |
| Ar | 39.94 | 0.00000 | 0.0000 | 0 | 0.0 |
| H2S | 34.082 | 0.00001 | 0.0002 | 5 | 0.1 |
| COS | 60.076 | 0.00000 | 0.0001 | 3 | 0.0 |
| | | 1.000 | 19.4804 | 451865 | 23195.9 |

This treated syngas can then be directed to a vessel that contains sulfur impregnated carbon pellets. This unit, supplied by Calgon Carbon and others, can remove up to 99% of the mercury from the syngas. This device is not illustrated in FIG. 1.

### Clean Syngas Supply

After clean up, the syngas is ready to be used as a fuel in both the GT and the duct burners in the HRSG. However, for the GE Frame 7FB 150, the required fuel pressure is nominally 460 psia. For the duct burners, the required fuel pressure is nominally 50 psia. Therefore, in the interest of efficiency, this fuel can be expanded from the clean syngas pressure of approximately 1250 psia to its operational pressure.

The gas turbine utilized in this example is the GE Frame 7FB. Although it is an engine that many consider to be the most likely candidate for IGCC power plants, there is no reason why other GT engines, either larger or smaller, or supplied by other manufacturers cannot be utilized in this power plant embodiment, and can be deemed an equivalent to item 150.

To further increase efficiency, the syngas fuel in this example is preheated prior to its introduction into the expanders. The lower level heat for the fuel gas is provided by hot water that comes from the intercooling of the oxygen stream during the compression process. See stream FUEL1 152, which is the clean syngas supply. This stream connects to heat exchanger HX3 154, which absorbs the heat from the oxygen intercooler loop. The clean syngas exits at a nominal temperature of 320° F. From here it travels to heat exchanger HX4 156, which preheats the syngas to a nominal 935° F., and cools the diluent (stream DIL1 158, oxygen depleted) to a nominal 1000° F. This preheated syngas is now directed to the syngas expander(s), devices EX1 160 and EXP2 162 (although shown as two expanders, the syngas expander may be built as a single unit, similar to an ST with an extraction port). The syngas is expanded down to its working pressure, a nominal 460 psia for the GT supply, and a nominal 50 psia for the duct burner supply. The GT fuel expander produces a nominal 10 MW, while the duct burner expander produces a nominal 11 MW. The syngas fuel is directed to the appropriate connection, the GT (stream FUELA4 164) or the duct burners (stream DBGAS1 166), after exiting from the expander(s).

As a result of using a significant portion of the fuel in the duct burners, which would be more than 10%, a second syngas expander can be utilized to expand fuel to the low pressures required by the duct burners. This provides additional power and increases the efficiency of the present invention.

In addition, the preheating of the syngas to 935° F., which is much more than the conventional IGCC syngas preheat temperature of 300° to 400° F., allows the expanders to produce more power. This also serves to increase the efficiency of the present invention.

### Gas Turbine

The gas turbine engine used for this model is the GE Frame 7FB or its equivalent 150. It is modeled as a group of components in the schematic, including a compressor, air extraction, combustor, and turbine section. A separate air stream is shown to model the cooling air that bypasses the combustor, and is used to cool the hot components in the turbine section of the GT. This model is contained in a rectangular box on the schematic and labeled GE 7FB GT. The electrical output for this machine is 232 MW. Note that the preferred embodiment of the invention is not limited to any particular manufacturer or model of GT, however, the model used was provided to demonstrate the principles of the invention.

To increase the efficiency of the GT, higher temperature fuel and higher temperature diluent increase the energy input to the GT, and thus decrease the required amount of fuel (syngas) consumption. With the ITM process, the diluent is supplied at 1600° F., and is utilized to preheat the fuel to the expanders to a nominal 935° F. This is much higher than the temperatures of conventional IGCC plants. After expanding in the fuel gas expander and producing power, the fuel gas for the GT is at a nominal 652° F., which is still significantly higher than the fuel gas temperatures in the conventional IGCC plants.

The cooled diluent, which was utilized to preheat the syngas fuel, is 1000° F., and supplied to the GT in this condition. Again, this is much higher than the temperatures in the conventional IGCC plants.

The higher diluent and fuel gas temperatures into the GT significantly increase the efficiency of the GT, and thus increase the efficiency of the present invention.

### HRSG

The GT exhausts into a Heat Recovery Steam Generator (HRSG). The HRSG for this application is a single-pressure once-thru design producing main steam at sufficient pressure to provide 4500 psia at the connection to the steam turbine. Steam is produced at this single pressure only, yet the stack temperature for this HRSG is calculated to be 187° F. With this arrangement, stack temperatures will nominally be 180° to 250° F., just as in the conventional HRSG's. Feedwater into the HRSG can be preheated utilizing low-pressure extraction steam from the steam turbine. Some feedwater is preheated in the HRSG before it is utilized in the high temperature sections of the syngas cooler (see stream STSYN1 168).

The main steam and reheat steam temperatures in this example are 1200° F. (nominal 650° C.). The highest temperature superheater and reheater sections of the HRSG are constructed of advanced stainless steel alloys, however, other high temperature materials may be employed.

The duct burner can be of conventional construction, designed to burn syngas (or in the case of CO₂ capture, both syngas and hydrogen). It is designed for start-up on natural gas; however, it could also be designed for start-up with other fuels. The firing temperatures downstream of at least one section of the duct burners are in the range of 1600° F. to 1800° F. during normal operation, so high temperature stainless liners may be utilized in this section of the HRSG, along with high temperature alloys for other critical items in this region, such as tubing supports. Again, other methods to make this HRSG acceptable for the higher firing temperatures such as ceramic linings can be utilized in the preferred embodiment of the present invention.

Note that the schematic indicates two duct burners in the HRSG. This arrangement is utilized for part load operation, as one portion of the duct burner grid can be maintained at a sufficient firing level to maintain the required air temperatures to the ITM modules, while the other portion is operated at a lower firing level, higher firing level, or even completely shut off. This method of control could include multiple duct burner sections, in lieu of the two sections shown in this example.

The exhaust gases downstream of the duct burners flow through the various stages of air (gaseous stream with oxygen content) heating, steam superheating, reheating, and water heating sections of the HRSG, producing steam for the steam turbine (ST). Once the energy has been recovered from the exhaust gases, they are vented to atmosphere through the HRSG stack 170.

### Steam Turbine

The steam turbine in this example is similar to the conventional IGCC steam turbine, and would likely have an opposed high pressure/intermediate pressure (HP/IP) section, with a crossover to an low pressure (LP) section, however, other ST arrangements are acceptable, as are other steam pressures and temperatures.

Note that the ST in this example, besides utilizing supercritical pressures, will also be designed for ultrasupercritical steam temperatures. At the current time, inlet and reheat steam temperatures for advanced coal plants are in the range of 1112° F. (600° C.) to 1148° F. (620° C.). Future steam plants are being designed for steam conditions of 1292° F. (700° C.). Steam temperatures of 1202° F. (650° C.) have been utilized in this analysis.

HP steam from the HRSG combines with HP steam from the syngas cooler and is then directed to the inlet of the HP section 172 of the ST. If desired, the steam from the syngas cooler(s) could be directed to the HRSG for further heating prior to being directed to the HP inlet of the ST. Some steam can be extracted from this section of the ST for use in the gasification process, if required. After expanding to a nominal 1100 psia, the expanded steam is returned to the HRSG and reheated to 1200° F. in this example. In addition, steam generated in the sulfuric acid plant, which is part of the cold gas clean up system, is combined with this HP section exhaust steam before being sent to the reheater sections of the HRSG.

This reheated steam from the HRSG is sent to the inlet of the IP section 174 of the ST. The steam expands to the crossover pressure 176, and exits the IP section of the ST. Some steam is extracted from this section of the ST, and used in the coal preheating process.

Steam from the IP section exhaust is directed to the LP section 178 of the ST, however, some of this flow is extracted from the crossover and used in the various processes in the IGCC plant, mostly in the cold gas clean up function. In the LP section, steam expands down to the condensing pressure of 0.63 psia. However, some steam is extracted from the LP section at various points in the steam path to provide steam for heating purposes. Note that the flow quantity and steam pressure for the various extractions are shown for this example, however, other pressures, number of extractions, and extraction flows could be utilized.

This ST will most likely have all three sections connected on one shaft driving a generator. The output for this ST is calculated to be 316.3 MW at the generator terminals.

Note that the conventional IGCC plants generate most of their process steam in the syngas coolers and/or the HRSG. Since this steam is produced at process pressure, it generates no electricity, but is directly consumed. In the preferred embodiment of the present invention, this process steam is extracted from the appropriate section of the ST. Therefore, steam is produced in this example at 4500 psia, 1200° F., and expanded to a nominal 1100 psia, and then reheated to 1200° F. and expanded further to the process steam pressure of 87 psia. Therefore, this steam generates a significant amount of electricity before it is finally sent to process, nominally 8300 MW in this example. This method of steam utilization increases the efficiency of the preferred embodiment compared to the conventional IGCC practice.

### Performance Summary

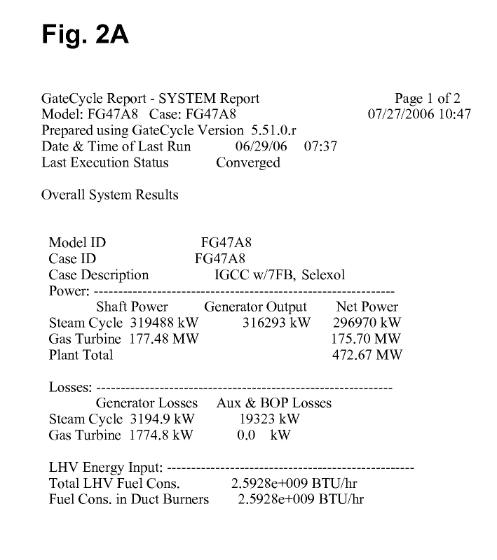

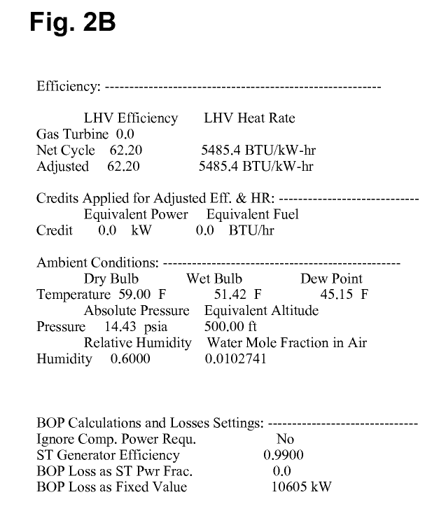

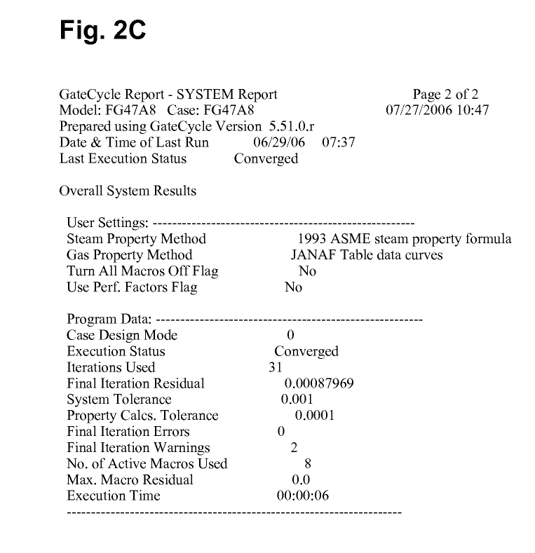

Based upon a 3000 ton per day (TPD) dry coal input, operating at ISO conditions, the example provided in the present invention can produce 473 MW. With a higher heating value of 10,810 Btu/lb for the coal as received, and 3504 TPD AR, the heat input for this plant is 3157 mM Btu/hr, which is equivalent to 51.1% efficiency on an HHV basis. FIGS. 2A, 2B, and 2C provide a summary of the present invention's outputs.

### CO₂ Sequestration

With global warming becoming more of a concern, and with the Kyoto Protocol being accepted by over 150 countries, the future use of coal in power plants may be predicated on the utilization of CO₂ sequestration. Therefore, an efficient coal plant that can separate CO₂ from its atmospheric exhaust is needed.

To meet this objective, the highly efficient plant described in this application can be designed for CO₂ removal, and with a minimal effect on the plant's output and efficiency. To achieve this, first the carbon bearing compounds must be removed from the fuel stream. The first step is to convert the clean syngas fuel from a mixture of primarily CO and H₂ to a mixture of primarily CO₂ and H₂. This is accomplished through the Water Gas Shift (WGS) reaction. When water vapor (steam) and CO are passed through catalysts at the proper temperature, they react to form CO₂ and H₂. As the CO is converted to CO₂, the water vapor releases H₂, and this hydrogen, along with hydrogen already contained in the syngas, can be removed from the stream. Ultimately, a large portion of the CO can be converted to CO₂ (about 99% in this example), and approximately 99% of the hydrogen in the stream can then be separated for use as fuel. This leaves a stream of pressurized gas that is comprised of mostly CO₂. This stream can be compressed and then sequestered underground, in the ocean, or in another suitable place that keeps the CO₂ from entering the atmosphere.

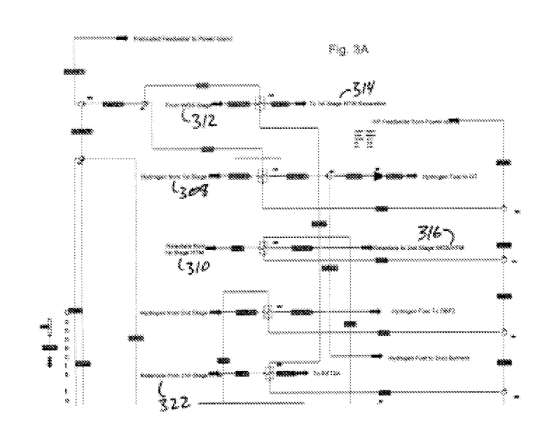

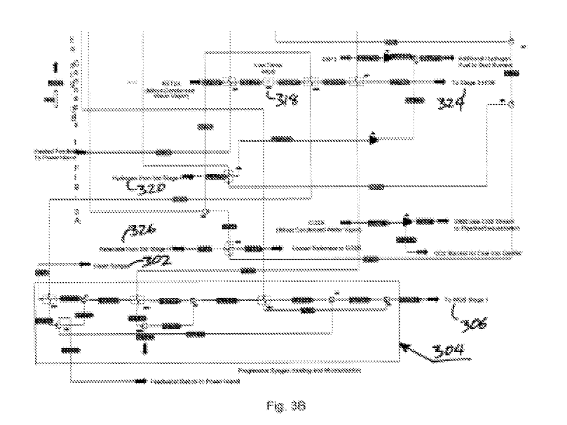

The attached schematic, FIG. 3 (note that by reference, FIG. 3 contains two sheets, FIGS. 3A, and 3B, shows the process for separating hydrogen from the clean syngas fuel. With the energy flow in this preferred embodiment of the present invention, it is advantageous not to use a sour gas shift reaction, as this reduces the energy that can be effectively recovered from the raw syngas. In addition, by utilizing a sweet gas shift reaction (where the shift reaction occurs after the syngas clean up process), problems with contamination of the HTM membranes are greatly reduced.

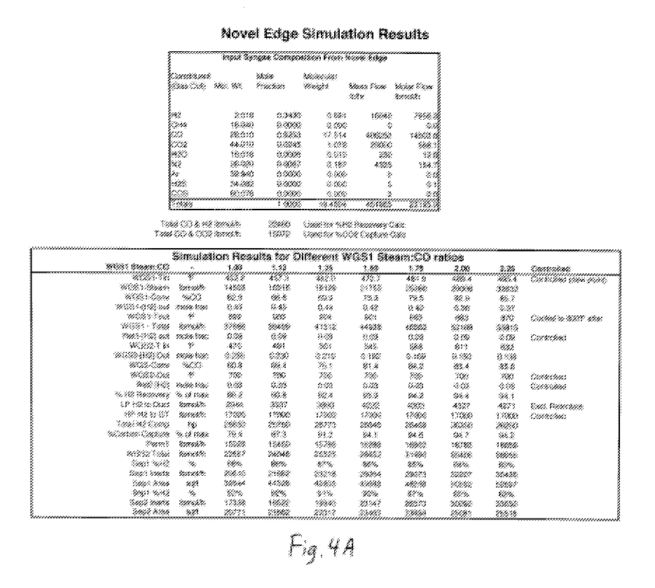

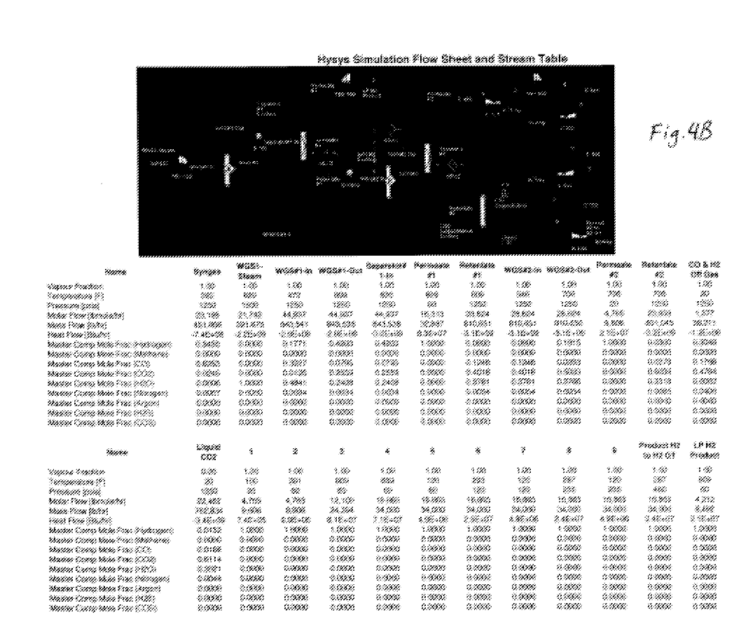

The hydrogen is separated in steps, utilizing Eltron Research's HTM technology, which consists of membranes that selectively allow hydrogen to permeate, while other gases cannot. FIG. 4A and FIG. 4B illustrate the first two steps of the integrated WGS/HTM separation process. In this system, steam and syngas are mixed, and then reacted in the first stage WGS reaction. This converts some CO to CO₂, and converts a commensurate molar amount of H₂O to H₂. This reaction also releases heat, and increases the temperature of the stream. Note that in FIG. 4A and FIG. 4B, the flows need to be increased by 25% to reflect the increased fuel that is required for this plant configuration.

Referring to FIG. 3, in this system, the clean syngas 302 is heated, and then water is sprayed into the syngas stream to moisturize the syngas. By repeating this process several times, the required amount of water vapor is introduced into the syngas stream. This equipment is noted by the rectangle with the notation “Progressive Syngas Heating and Moisturization” 304. This process is more efficient than just adding steam to the syngas. This is because steam boils at varying temperatures, based upon its pressure.

Since a pressure differential is required to get steam into the syngas stream, in this example, 1500 psia steam would be required, as the pressure of the clean syngas is 1250 psia. Water at 1500 psia boils into steam at 596° F. Therefore, high-end energy above 596° F. is required to generate this steam.

However, the raw syngas contains very little moisture, so that after a small portion of the heated syngas is sprayed with pressurized water at 1500 psia (versus steam), the water becomes steam, however, the partial pressure of this water may only be 100 psia. The boiling temperature for water at 100 psia is 328° F. Therefore, the progressive heating and moisturization of the syngas allows for the use of lower-end energy to provide this moisturization. This leaves high-end energy for other functions in the plant, and thus serves to increase the efficiency of the present invention.

From here, the moisturized syngas goes to a first stage WGS reaction 306 to convert some H₂O and CO to H₂ and CO₂. This gas 312 is sent to the HTM membranes 314, and some H₂ 308 permeates the membranes. The remaining gas (called retentate) 310 continues to the 2^{nd} stage WGS reaction 316 and more H₂ is produced. Again, this stream is sent to the 2^{nd} stage HTM membranes where more H₂ 320 permeates the membranes. Finally, the retentate 322 is cooled and a low temperature WGS reaction 318 is utilized for its higher conversion rate, where only 0.5% CO (dry basis) remains unconverted. The stream is directed to a third stage of HTM 324, where more H₂ is removed. The retentate 326 now contains only about 1% H₂, and is compressed to the typical pipeline pressure of 2900 psia.

The initial 2 stages of the integrated WGS/HTM process are shown in FIGS. 4A and 4B (note that recorded flows in these figures need to be increased by 25%), while Tables 9A and 9B provide the data for the 3^{rd} stage of the integrated WGS/HTM process.

TABLE 9A

| | | | | | | | |
|---|---|---|---|---|---|---|---|
| Xfeed | P | Pperm | Rt | Eff | R | Xnp | Perf K |

3rd Stage WGS/HTM System
As Designed by NORAM

| | | | | | | | | |
|---|---|---|---|---|---|---|---|---|
| WGS# 1 | 0.4203 | 1250 | 60 | 0.9305 | 0.928 | 0.8635 | 0.0901 | 8.76 |
| WGS# 2 | 0.1915 | 1250 | 20 | 0.9314 | 0.933 | 0.8690 | 0.0301 | 11.97 |

Low Temp Shift, 3rd Stage
Removal (See Calcs Below)

| | | | | | | | | |
|---|---|---|---|---|---|---|---|---|
| WGS# 1 | 0.4203 | 1250 | 60 | 0.9305 | 0.928 | 0.8635 | 0.0901 | 8.76 |
| WGS# 2 | 0.1915 | 1250 | 20 | 0.9314 | 0.933 | 0.8692 | 0.0300 | 11.97 |
| WGS# 3 | 0.0698 | 1250 | 5 | 0.9465 | 0.928 | 0.8783 | 0.0090 | 17.45 |

Retentate #2

| Constituent | | Mole | Molecular | Flow | Flow |
|---|---|---|---|---|---|
| (Gas Out) | Mol. Wt. | Fraction | Weight | lb/hr | moles |
| H2 | 2.016 | 0.03000 | 0.0605 | 1443 | 716 |
| CH4 | 16.040 | 0.00000 | 0.0000 | 0 | 0 |
| CO | 28.010 | 0.02790 | 0.7815 | 18645 | 666 |
| CO2 | 44.010 | 0.60380 | 26.5732 | 633984 | 14405 |
| H2O | 18.016 | 0.33180 | 5.9777 | 142616 | 7916 |
| N2 | 28.020 | 0.00650 | 0.1821 | 4345 | 155 |
| Ar | 39.940 | 0.00000 | 0.0000 | 0 | 0 |
| H2S | 34.082 | 0.00000 | 0.0001 | 6 | 0 |
| COS | 60.076 | 0.00000 | 0.0001 | 4 | 0 |
| | | 1.0000 | 33.5752 | 801043 | 23858 |

After Low Temp Shift, CO to 0.5% Dry

| Constituent | | Mole | Molecular | Flow | Flow | CO | | Mol |
|---|---|---|---|---|---|---|---|---|
| (Gas Out) | Mol. Wt. | Fraction | Weight | lb/hr | moles | Dry | Residual | Conv. |
| H2 | 2.016 | 0.06979 | 0.1407 | 2618 | 1299 | | | |
| CH4 | 16.040 | 0.00000 | 0.0000 | 0 | 0 | | | |
| CO | 28.010 | 0.00444 | 0.1244 | 2314 | 83 | 0.0050 | −0.0000 | 583 |
| CO2 | 44.010 | 0.80546 | 35.4481 | 659643 | 14988 | | | |
| H2O | 18.016 | 0.11197 | 2.0173 | 37539 | 2084 | | | |
| N2 | 28.020 | 0.00833 | 0.2335 | 4345 | 155 | | | |
| Ar | 39.940 | 0.00000 | 0.0000 | 0 | 0 | | | |
| H2S | 34.082 | 0.00000 | 0.0001 | 6 | 0 | | | |
| COS | 60.076 | 0.00000 | 0.0001 | 4 | 0 | | | |
| | | 1.0000 | 37.9642 | 706469 | 18609 | 16525 | | |

Note:
Cooling to 350 F. and reheat to 400 F. condenses some water from retentate #2

TABLE 9B
Retentate #3

| | | | | | | H2 | |
|---|---|---|---|---|---|---|---|
| Constituent | | Mole | Molecular | | Flow | Removal | |
| (Gas Out) | Mol. Wt. | Fraction | Weight | Flow lb/hr | moles | lb/hr | moles |
| H2 | 2.016 | 0.00903 | 0.0182 | 318 | 158 | 2300 | 1141 |
| CH4 | 16.040 | 0.00000 | 0.0000 | 0 | 0 | | |
| CO | 28.010 | 0.00473 | 0.1325 | 2314 | 83 | | |
| CO2 | 44.010 | 0.85807 | 37.7637 | 659643 | 14988 | | |
| H2O | 18.016 | 0.11929 | 2.1490 | 37539 | 2084 | | |
| N2 | 28.020 | 0.00888 | 0.2488 | 4345 | 155 | | |
| Ar | 39.940 | 0.00000 | 0.0000 | 0 | 0 | | |
| H2S | 34.082 | 0.00000 | 0.0002 | 6 | 0 | | |
| COS | 60.076 | 0.00000 | 0.0001 | 4 | 0 | | |
| | | 1.0000 | 40.3124 | 704169 | 17468 | | |

Retentate #3 After Cooling to 125 F.

| | | | | | | H2O | |
|---|---|---|---|---|---|---|---|
| Constituent | | Mole | Molecular | | Flow | Removal | |
| (Gas Out) | Mol. Wt. | Fraction | Weight | Flow lb/hr | moles | lb/hr | moles |
| H2 | 2.016 | 0.01007 | 0.0203 | 318 | 158 | 32464 | 1802 |
| CH4 | 16.040 | 0.00000 | 0.0000 | 0 | 0 | | |
| CO | 28.010 | 0.00527 | 0.1477 | 2314 | 83 | | |
| CO2 | 44.010 | 0.95677 | 42.1075 | 659643 | 14988 | | |
| H2O | 18.016 | 0.01798 | 0.3239 | 5074 | 282 | | |
| N2 | 28.020 | 0.00990 | 0.2774 | 4345 | 155 | | |
| Ar | 39.940 | 0.00000 | 0.0000 | 0 | 0 | | |
| H2S | 34.082 | 0.00001 | 0.0002 | 6 | 0 | | |
| COS | 60.076 | 0.00000 | 0.0001 | 4 | 0 | | |
| | | 1.0000 | 42.8771 | 671704 | 15666 | | |

Note:
Cooling to 125 F. removes water from retentate #3

Note that by utilizing the “Progressive Syngas Heating and Moisturization” process 304, no steam is required from an external source, namely, the power island. As steam is consumed from the power island for the WGS reaction, this reduces the flow through the ST, which reduce power output. This has a negative impact on the IGCC plant output and efficiency. However, through progressive heating and moisturization of the syngas, utilizing heat that is generated in the WGS reaction (along with a water spray), the syngas is moisturized and heated to the required level before entering the first WGS reaction. This process contributes greatly to the efficiency of this plant when CO₂ removal is required. In essence, when water is added to the hot syngas, it becomes water vapor at its partial pressure in the stream (approximately 50 to 700 psia in this example). Therefore, the use of steam at a nominal 1500 psia, in lieu of water at 1500 psia, does not require as much high-end energy (high temperature energy) to moisturize the syngas stream.

Not only does this progressive heating and moisturization process utilize less energy, it absorbs the heat generated by the WGS reaction, and utilizes it to completely provide the necessary heat for the moisturization, and in addition provide preheated feedwater for the power island. No steam is taken from the power island, which ultimately reduces power output and lowers the conventional IGCC overall efficiency.

IGCC with CO₂ Removal

With the syngas now separated into two streams, one that is essentially pure hydrogen, and the other a stream comprised of mainly CO₂, the hydrogen can be utilized as fuel in both the GT and the duct burners, and the final retentate can be compressed to 2900 psia for sequestration. Due to the fact that the WGS reaction is exothermic, and actually consumes energy, less energy content is available in the hydrogen as was available in the syngas. For this reason, the overall coal input has been increased by 25% to provide the additional hydrogen required in the process.

The use of a substantial amount of fuel in the duct burners (more than 10% of the syngas) is of an advantage in this preferred embodiment of the present invention. That is because the hydrogen fuel to the duct burners is required at a much lower pressure than the supply pressure for the GT (50 psia versus 460 psia in this example). This will serve to increase the efficiency of the present invention when CO₂ separation is implemented.

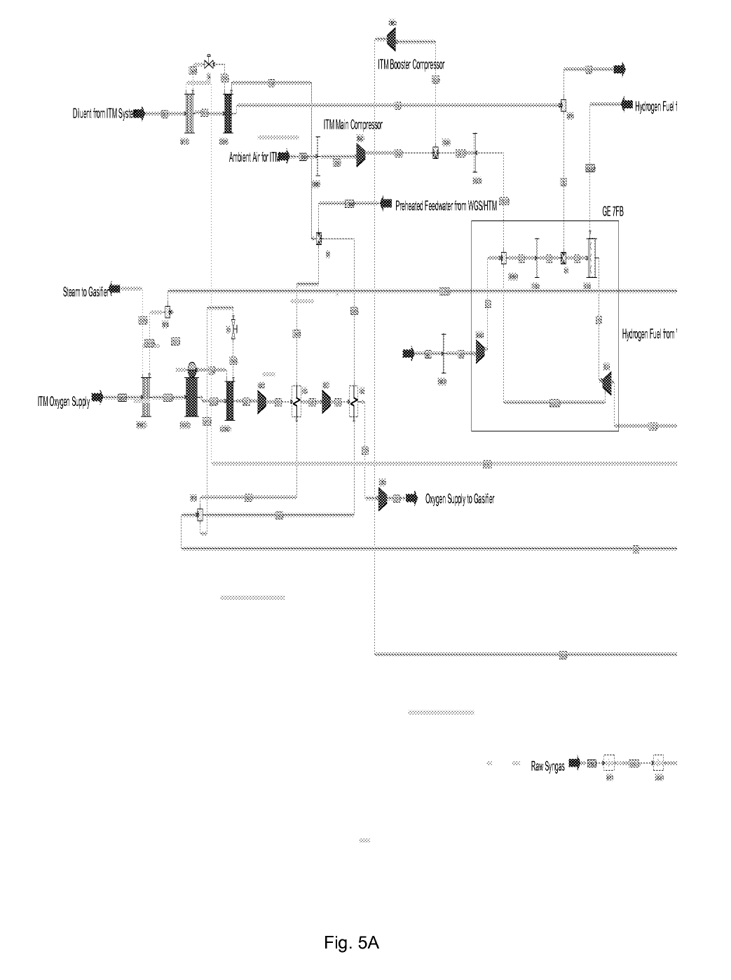

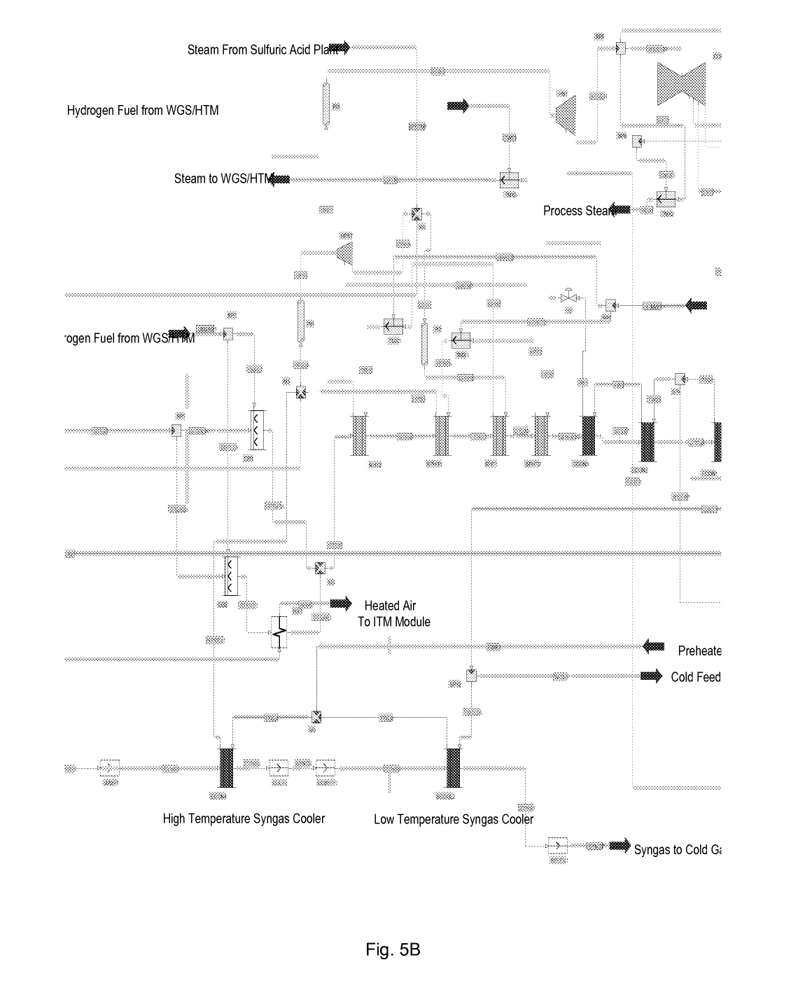

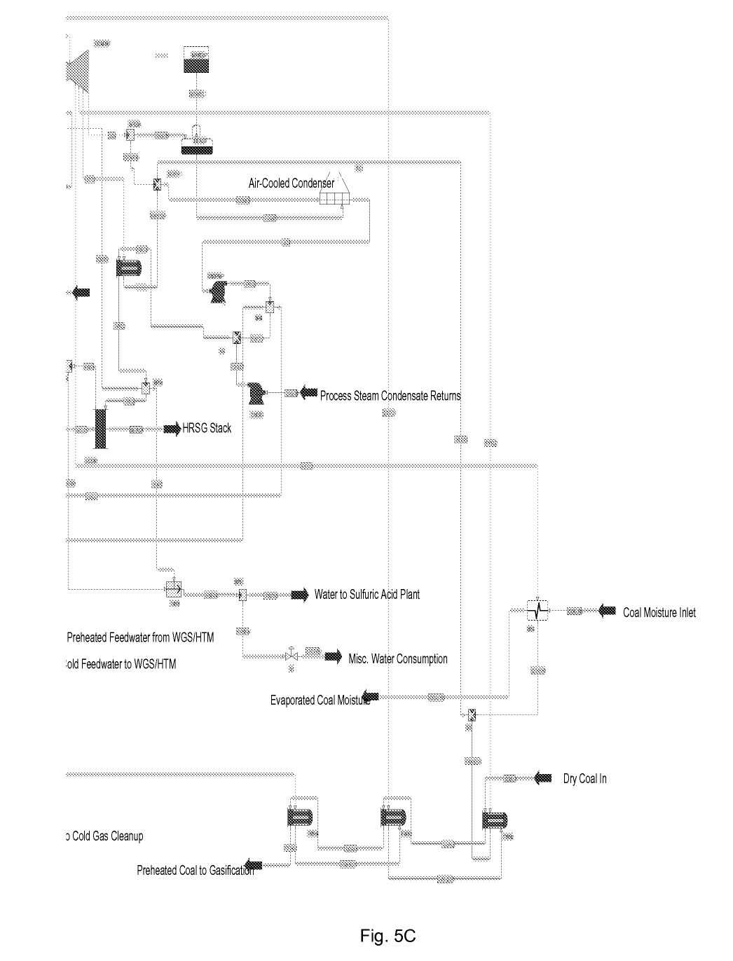

FIG. 5, which shall in name include the schematic drawings of FIGS. 5A, 5B, and 5C, illustrates the power island process flow diagram for this high efficiency IGCC plant that now includes CO₂ separation. Hydrogen is used as fuel, and the syngas expanders are no longer utilized, as the fuel pressure is now required to pass the hydrogen through the HTM membranes. Since the hydrogen will come from the HTM process in a preheated condition, it has little value for absorbing heat. Therefore, the power island process has changed such that the cooling water from the ITM compressor intercoolers is combined with some preheated feedwater from the HTM system and directed to a heat recovery device. This device utilizes the heat contained in the diluent from the ITM system to convert this feedwater into HP steam. This HP steam is directed to the inlet of the HP steam turbine.

In addition, for syngas cooling, this IGCC plant that includes CO₂ removal utilizes preheated feedwater from the WGS/HTM system in lieu of preheated water from the HRSG, as was the example when CO₂ removal was not required.

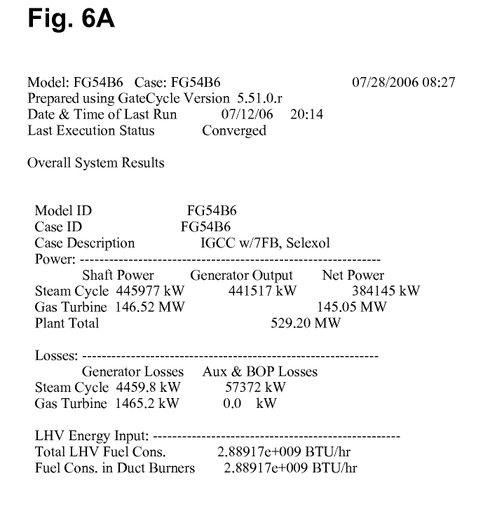

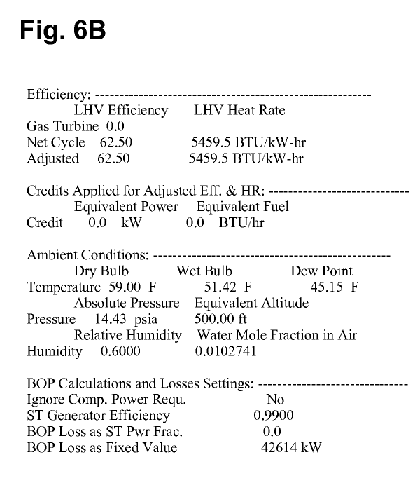

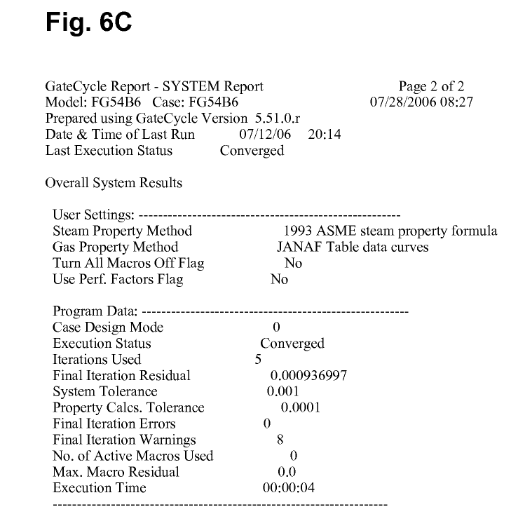

For a detailed review of FIG. 5, the process schematic for the power island that includes CO₂ separation, see Tables 12 through 15. They contain the stream data for each process line on the process schematic, including pressure, temperature, flow, and enthalpy for each stream. For the output summary for this plant, refer to FIGS. 6A and 6B.

TABLE 10

| | | | Temperature | Pressure | Flow | Enthalpy | |
|---|---|---|---|---|---|---|---|
| Stream | From | To | Degrees F. | psia | lb/hr | btu/lb | Quality |
| CO2BL1 | C4 | — | 186.6830444 | 1967.867676 | 31250 | 21.16055107 | 0.0E+01 |
| CW10 | HX5 | HX1 | 643.7653809 | 5200.000977 | 380000 | 661.007019 | 0.0E+01 |
| CW11 | HX6 | HX12 | 583.4807739 | 5200.000977 | 130000 | 584.0513916 | 0.0E+01 |
| CW11A | HX12 | SP10 | 396.3110352 | 5200.000977 | 130000 | 377.6835327 | 0.0E+01 |
| CW11B | SP10 | M5 | 396.3110352 | 5200.000977 | 130000 | 377.6835327 | 0.0E+01 |
| CW11C | SP10 | — | 396.3110352 | 5200.000977 | 0.0E+01 | 377.6835327 | 0.0E+01 |
| CW12 | HX7 | — | 354.7708435 | 5200.000977 | 40000 | 334.9448242 | 0.0E+01 |
| CW2 | HX1 | M1 | 724.9005127 | 5200.000977 | 380000 | 788.9011841 | 1 |
| CW21 | SP7 | HX8 | 90 | 5200.000977 | 10000.03027 | 71.81587219 | 0.0E+01 |
| CW22 | HX8 | M3 | 606.1578369 | 5200.000977 | 10000.03027 | 611.9309082 | 0.0E+01 |
| CW27 | SP7 | HX9 | 90 | 5200.000977 | 320000 | 71.81587219 | 0.0E+01 |
| CW28 | HX9 | SP2 | 596.258606 | 5200.000977 | 320000 | 599.6304321 | 0.0E+01 |
| CW29 | SP2 | HX10 | 596.258606 | 5200.000977 | 200000 | 599.6304321 | 0.0E+01 |
| CW3 | SP3 | HX2 | 90 | 5200.000977 | 160000 | 71.81587219 | 0.0E+01 |
| CW30 | HX10 | HX11 | 450.4500122 | 5200.000977 | 200000 | 434.5517883 | 0.0E+01 |
| CW30A | HX11 | SP9 | 121.6151962 | 5200.000977 | 200000 | 102.7763977 | 0.0E+01 |
| CW30B | SP9 | M4 | 121.6151962 | 5200.000977 | 60000.00391 | 102.7763977 | 0.0E+01 |
| CW30C | SP9 | M6 | 121.6151962 | 5200.000977 | 130000 | 102.7763977 | 0.0E+01 |
| CW30D | SP9 | — | 121.6151962 | 5200.000977 | 10000 | 102.7763977 | 0.0E+01 |
| CW4 | HX2 | M1 | 653.3347778 | 5200.000977 | 160000 | 674.2513428 | 0.0E+01 |
| CW5 | SP4 | HX3 | 90 | 5200.000977 | 130000 | 71.81587219 | 0.0E+01 |
| CW6 | HX3 | HX6 | 705.8637085 | 5200.000977 | 130000 | 753.5681763 | 1 |
| CW7 | SP5 | HX4 | 90 | 5200.000977 | 40000 | 71.81587219 | 0.0E+01 |
| CW8 | HX4 | HX7 | 651.0131836 | 5200.000977 | 40000 | 671.0039063 | 0.0E+01 |
| CW9 | SP6 | HX5 | 90 | 5200.000977 | 380000 | 71.81587219 | 0.0E+01 |
| DBFL1 | SP1 | — | 126.3505783 | 60 | 7356.035156 | 227.2802277 | 0.0E+01 |
| FWA1 | — | SP3 | 90 | 5200.000977 | 1040000 | 71.81587219 | 0.0E+01 |
| FWA2 | SP3 | SP4 | 90 | 5200.000977 | 880000 | 71.81587219 | 0.0E+01 |
| FWA3 | SP4 | SP5 | 90 | 5200.000977 | 750000 | 71.81587219 | 0.0E+01 |
| FWA4 | SP5 | SP6 | 90 | 5200.000977 | 710000.0625 | 71.81587219 | 0.0E+01 |
| FWA5 | SP6 | SP7 | 90 | 5200.000977 | 330000.0625 | 71.81587219 | 0.0E+01 |
| FWB6 | SP2 | M3 | 596.258606 | 5200.000977 | 120000.0078 | 599.6304321 | 0.0E+01 |
| FWJ1 | M3 | HX13 | 625.6883545 | 5200.000977 | 170000 | 636.8952026 | 0.0E+01 |
| FWJ2 | HX13 | M7 | 485.5770874 | 5200.000977 | 170000 | 472.3883972 | 0.0E+01 |
| FWRET1 | M1 | SP8 | 706.6416626 | 5200.000977 | 539999.9375 | 754.9308472 | 1 |
| FWRET2 | SP8 | — | 706.6416626 | 5200.000977 | 500000 | 754.9308472 | 1 |
| FWRET3 | SP8 | M3 | 706.6416626 | 5200.000977 | 39999.96875 | 754.9308472 | 1 |
| GTFL1 | SP1 | C1 | 126.3505783 | 60 | 33753 | 227.2800903 | 0.0E+01 |
| GTFL2 | C1 | — | 660.458313 | 475 | 33753 | 2077.167969 | 0.0E+01 |
| PERM1A | — | HX2 | 809 | 60 | 41109.03516 | 2595.459961 | 0.0E+01 |
| PERM1B | HX2 | SP1 | 126.3505783 | 60 | 41109.03516 | 227.2802277 | 0.0E+01 |
| PERM2A | — | HX4 | 705.999939 | 20 | 12008.00488 | 2235.889893 | 0.0E+01 |
| PERM2B | HX4 | — | 124.2202682 | 20 | 12008.00488 | 219.9679871 | 0.0E+01 |
| PERM2C | C3 | M2 | 368.4320068 | 60 | 12008.00488 | 1062.63208 | 0.0E+01 |

TABLE 11

| | | | Temperature | Pressure | Flow | Enthalpy | |
|---|---|---|---|---|---|---|---|
| Stream | From | To | Degrees F. | psia | lb/hr | btu/lb | Quality |
| PERM2Q | — | C3 | 123.9999924 | 20 | 12008.00488 | 219.2119446 | 0.0E+01 |
| PERM3A | — | HX8 | 667.000061 | 5 | 2875 | 2099.958496 | 0.0E+01 |
| PERM3B | HX8 | C2 | 119.1318436 | 5 | 2875 | 202.505249 | 0.0E+01 |
| PERMB | C2 | M2 | 794.6778564 | 60 | 2875 | 2545.407959 | 0.0E+01 |
| PERMB | M2 | — | 451.0436401 | 60 | 14883.00391 | 1349.065063 | 0.0E+01 |
| RET1 | — | HX3 | 809 | 1250 | 1013313 | 237.5109406 | 0.0E+01 |
| RET2 | — | HX5 | 705.999939 | 1250 | 1001306 | 182.3054047 | 0.0E+01 |
| RET3 | — | HX9 | 667.000061 | 1100 | 880211 | 150.0695496 | 0.0E+01 |
| RET3B | HX9 | — | 109.1809235 | 1100 | 880211 | −43.73590851 | 0.0E+01 |
| RET3BB | — | C4 | 110.0000076 | 1100 | 671704 | 3.047713995 | 0.0E+01 |
| RET3D | C4 | — | 238.9307251 | 2900 | 640454 | 34.56742859 | 0.0E+01 |
| SEPIN1 | HX1 | — | 800 | 1250 | 1054435 | 325.2308044 | 0.0E+01 |
| SYNGAS | — | HX11 | 99.99997711 | 1250 | 564858.1875 | 14.3559351 | 0.0E+01 |
| SYNGS2 | HX11 | M4 | 420.616394 | 1250 | 564858.1875 | 130.6649628 | 0.0E+01 |
| SYNGS3 | M4 | HX12 | 385.8161011 | 1250 | 624858.1875 | 120.7561569 | 0.0E+01 |
| SYNGS4 | HX12 | M5 | 498.4353638 | 1250 | 624858.1875 | 163.2653351 | 0.0E+01 |
| SYNGS5 | M5 | HX13 | 477.6106873 | 1250 | 754858.1875 | 161.4051208 | 0.0E+01 |
| SYNGS6 | HX13 | M6 | 570.1108398 | 1250 | 754858.1875 | 198.0865326 | 0.0E+01 |
| SYNGS7 | M6 | M7 | 495.7246094 | 1250 | 884858.125 | 173.0204315 | 0.0E+01 |
| SYNGS8 | M7 | — | 493.8756104 | 1250 | 1054858.25 | 176.4275513 | 0.0E+01 |
| WGS3A | — | HX7 | 350.0000305 | 1250 | 883086 | 68.1968689 | 0.0E+01 |
| WGS3A1 | HX7 | FPT1 | 400 | 1250 | 883086 | 83.26819611 | 0.0E+01 |
| WGS3A2 | FPT1 | HX10 | 443.9815369 | 1250 | 883086 | 94.90918732 | 0.0E+01 |
| WGS3A3 | HX10 | HX6 | 579.8703003 | 1250 | 883086 | 131.9257813 | 0.0E+01 |
| WGS3C | HX6 | — | 667.7426147 | 1250 | 883086 | 156.6334381 | 0.0E+01 |
| WGSIN2 | HX3 | — | 546 | 1250 | 1013313 | 149.1729279 | 0.0E+01 |
| WGSIN3 | HX5 | — | 350.0000305 | 1250 | 1001306 | −43.5312233 | 0.0E+01 |
| WGSOT1 | — | HX1 | 899 | 1250 | 1054435 | 371.7825317 | 0.0E+01 |

TABLE 12

| | | | Temperature | Pressure | Flow | Enthalpy | |
|---|---|---|---|---|---|---|---|
| Stream | From | To | Degrees F. | psia | lb/hr | btu/lb | Quality |
| AIR1 | — | DUCT1 | 58.99998856 | 14.43239689 | 3554000 | −0.241509497 | 4 |
| AIR2 | DUCT1 | 7FBC1 | 58.99998856 | 14.32439709 | 3554000 | −0.241509497 | 4 |
| AIRA2 | HX1 | — | 1610 | 490 | 1012249.938 | 402.6252747 | 4 |
| CD1 | 7FBC1 | 7FBSP1 | 820.1157227 | 257.8391418 | 3554000 | 188.8095856 | 4 |
| CD2 | 7FBSP1 | 7FBD2 | 820.1157227 | 257.8391418 | 2797102.25 | 188.8095856 | 4 |
| CD3 | 7FBD2 | M1 | 820.114502 | 214.0065002 | 2797102.25 | 188.8095856 | 4 |
| CD4 | M1 | GTB3 | 861.5877075 | 214.0065002 | 3588549.25 | 200.3296356 | 4 |
| CDEXT1 | 7FBSP1 | DUCT2 | 820.1157227 | 257.8391418 | 286000 | 188.8095856 | 4 |
| CDEXT2 | DUCT2 | ITMM1 | 820.114502 | 238.5012054 | 286000 | 188.8095856 | 4 |
| CHXDR1 | HX6 | M7 | 179.2797852 | 35 | 46000 | 147.3417816 | 0.0E+01 |
| CMIX2 | SP14 | SP9 | 175.053894 | 4802.112793 | 8250.636719 | 154.3586426 | 0.0E+01 |
| CMIX3 | SP9 | TMX2 | 175.053894 | 4802.112793 | 8250.636719 | 154.3586426 | 0.0E+01 |
| COAL1 | — | FWH2 | 100.000145 | 600 | 93750 | 69.57876587 | 0.0E+01 |
| COAL2 | FWH2 | FWH3 | 214.6862488 | 600 | 93750 | 184.1669464 | 0.0E+01 |
| COAL3 | FWH3 | FWH4 | 305.9277039 | 600 | 93750 | 276.7874146 | 0.0E+01 |
| COAL4 | FWH4 | — | 401.7137146 | 600 | 93750 | 377.3396301 | 0.0E+01 |
| COALW1 | — | HX6 | 100.0000305 | 14.70000267 | 45000.01953 | 68.03512573 | 0.0E+01 |
| COALW2 | HX6 | — | 213.0142517 | 14.70000267 | 45000.01953 | 1150.959351 | 1 |
| COND1 | MIXFHO | AC1 | 86.88021088 | 0.632653058 | 1875949.75 | 907.2695923 | 0.816043198 |
| CONDIN | SPLDA | MIXFHO | 86.88021088 | 0.632653058 | 1728388.75 | 976.1881104 | 0.882024884 |
| CRET1 | — | CNDR1 | 266 | 60 | 73688 | 234.9108429 | 0.0E+01 |
| CRET2 | CNDR1 | M4 | 274.013092 | 4802.112793 | 73688 | 252.6047668 | 0.0E+01 |
| CRH1 | M6 | PI2 | 742.5795898 | 1100 | 1952860.375 | 1348.000366 | 1 |
| CRH1B | PI2 | RHT1 | 739.5549316 | 1083.5 | 1952860.375 | 1347.000366 | 1 |
| CRH2 | RHT1 | TMX3 | 1049.999756 | 1071.5 | 1952860.375 | 1531.725098 | 1 |
| CRH3 | TMX3 | RHT2 | 1049.999756 | 1071.5 | 1952860.375 | 1531.725098 | 1 |
| CRHA | HPST | M6 | 755.4854736 | 1100 | 1850000.625 | 1356.470947 | 1 |
| DASTM | SPLDA | DEAER | 86.88021088 | 0.632653058 | 4255.240234 | 976.1881104 | 0.882024884 |
| DBFL2 | SP3 | DB1 | 350.0000305 | 50 | 11351.9248 | 998.7965088 | 0.0E+01 |
| DBFL2A | SP3 | DB2 | 350.0000305 | 50 | 10887.07617 | 998.7965088 | 0.0E+01 |
| DBGAS1 | — | SP3 | 350.0000305 | 50 | 22239 | 998.7965088 | 0.0E+01 |
| DIL1 | — | SPHT3 | 1600 | 460 | 791447 | 405.8459778 | 0.0E+01 |
| DIL1A | SPHT3 | ECON5 | 1588.366089 | 460 | 791447 | 402.5299377 | 0.0E+01 |
| DIL2 | ECON5 | SP15 | 1004.878174 | 460 | 791447 | 241.0751343 | 0.0E+01 |
| DIL3 | SP15 | M1 | 1004.878174 | 460 | 791447 | 241.0751343 | 0.0E+01 |
| DIL4 | SP15 | — | 1004.878174 | 460 | 0.0E+01 | 241.0751343 | 0.0E+01 |
| EXT1 | SP5 | TMX2 | 545.0579224 | 90.00000763 | 72655.36719 | 1302.892578 | 1 |
| EXT2 | CONDST | FWH1 | 182.8581543 | 8 | 77838.73438 | 1110.063477 | 0.970404327 |
| EXTC1 | CONDST | HX6 | 359.4873657 | 35 | 46000 | 1217.318481 | 1 |
| EXTC2 | CONDST | FWH2 | 260.2702942 | 20 | 8285.697266 | 1172.150391 | 1 |
| EXTC3 | SP5 | FWH3 | 545.0579224 | 90.00000763 | 7202.975586 | 1302.892578 | 1 |
| EXTC4 | IPST | FWH4 | 839.4290161 | 300 | 8233.428711 | 1441.87854 | 1 |
| FHMIXI | DEAER | AC1 | 86.88021088 | 0.632653058 | 575473.3125 | 54.90411377 | 0.0E+01 |
| FUELA4 | — | GTB3 | 660 | 460 | 33741.76172 | 2075.571289 | 0.0E+01 |

TABLE 13

| | | | Temperature | Pressure | Flow | Enthalpy | |
|---|---|---|---|---|---|---|---|
| Stream | From | To | Degrees F. | psia | lb/hr | btu/lb | Quality |
| FW1D | SP14 | ECON1 | 175.053894 | 4802.112793 | 1038551.375 | 154.3586426 | 0.0E+01 |
| FW2A | ECON1 | SP4 | 439.2961426 | 4786.113281 | 1038551.375 | 422.2418213 | 0.0E+01 |
| FW2B | SP4 | ECON2 | 439.2961426 | 4786.113281 | 990000.5 | 422.2418213 | 0.0E+01 |
| FW3 | ECON2 | ECON3 | 653.44104 | 4731.112793 | 990000.5 | 676.8942261 | 0.0E+01 |
| FWB1 | — | M9 | 706.6000366 | 5200.000977 | 430000 | 754.8578491 | 1 |
| FWC1 | CNDPMP | SP8 | 88.63121796 | 5200.000977 | 2451423 | 70.47751617 | 0.0E+01 |
| FWC1A | SP8 | M4 | 88.63121796 | 5200.000977 | 1033563.125 | 70.47751617 | 0.0E+01 |
| FWC2 | M4 | FWH1 | 102.0717239 | 4802.112793 | 1107251 | 82.59815216 | 0.0E+01 |
| FWC3 | FWH1 | SP14 | 175.053894 | 4802.112793 | 1107251 | 154.3586426 | 0.0E+01 |
| FWD2 | SCOOL2 | M9 | 631.2406616 | 5200.000977 | 230000.1094 | 644.1869507 | 0.0E+01 |
| FWD3 | M9 | ECON4 | 681.8122559 | 5200.000977 | 660000.125 | 716.2907715 | 0.0E+01 |
| FWF1 | — | TMX5 | 583.5 | 5200.000977 | 0.0E+01 | 584.074707 | 0.0E+01 |
| FWH1DR | FWH1 | MIXFHO | 111.0717239 | 7.519999981 | 77838.73438 | 79.06716919 | 0.0E+01 |
| FWH2DR | FWH2 | M7 | 109.000145 | 18.80000114 | 23722.09961 | 77.02861786 | 0.0E+01 |
| FWH3DR | FWH3 | FWH2 | 223.6862488 | 84.6000061 | 15436.4043 | 192.0957336 | 0.0E+01 |
| FWH4DR | FWH4 | FWH3 | 314.9277039 | 282 | 8233.428711 | 285.4906006 | 0.0E+01 |
| GSTM1 | HPST | TMX5 | 841.100708 | 1500.000122 | 0.0E+01 | 1391.606934 | 1 |
| GT3X7 | ECON3 | ECON2 | 687.2577515 | 14.70460033 | 4115428 | 172.8781586 | 4 |
| GTEX1 | TEX1 | SP1 | 1085.979858 | 14.93999958 | 4093189 | 277.7853088 | 4 |
| GTEX2A | SP1 | DB1 | 1085.979858 | 14.93999958 | 2046594.5 | 277.7852173 | 4 |
| GTEX2B | SP1 | DB2 | 1085.979858 | 14.93999958 | 2046594.5 | 277.7852173 | 4 |
| GTEX3 | M5 | RHT2 | 1841.138428 | 14.90399933 | 4115428 | 526.4234009 | 4 |
| GTEX3A | DB1 | M5 | 1957.617065 | 14.90399933 | 2057946.25 | 565.0014038 | 4 |
| GTEX3B | DB2 | HX1 | 1925.07312 | 14.93999958 | 2057481.5 | 553.3024292 | 4 |
| GTEX4 | RHT2 | SPHT1 | 1711.786133 | 14.8569994 | 4115428 | 484.5733337 | 4 |
| GTEX4B | HX1 | M5 | 1723.272705 | 14.93999958 | 2057481.5 | 487.8378906 | 4 |
| GTEX5 | SPHT1 | RHT1 | 1609.6521 | 14.80599976 | 4115428 | 451.8711853 | 4 |
| GTEX6 | RHT1 | SPHT2 | 1327.785278 | 14.78399944 | 4115428 | 363.3390503 | 4 |
| GTEX6A | SPHT2 | ECON3 | 1301.844116 | 14.70460033 | 4115428 | 355.32724 | 4 |
| GTEX8 | ECON2 | ECON1 | 467.3137512 | 14.62519932 | 4115428 | 111.0332489 | 4 |
| GXTM2 | TMX5 | — | 841.100708 | 1500.000122 | 0.0E+01 | 1391.606934 | 1 |
| HEAT | TMX2 | — | 319.8912354 | 87 | 80906.00781 | 1185.767334 | 1 |
| HG1 | GTB3 | TEX1 | 2420.119141 | 214.0065002 | 3622291.25 | 693.5748291 | 4 |
| HPATT2 | SP2 | TMX1 | 706.6000366 | 5000 | 70000 | 757.5561523 | 1 |
| HPATT3 | SP2 | TMX3 | 706.6000366 | 5000 | 0.0E+01 | 757.5561523 | 1 |
| HPS1 | V2 | SPHT2 | 1061.760254 | 4731.112793 | 990000.5 | 1429.164673 | 1 |
| HPS2 | SPHT2 | TMX1 | 1099.985596 | 4660.112793 | 990000.5 | 1462.142212 | 1 |
| HPS2A | TMX1 | SPHT1 | 1042.72998 | 4660.112793 | 1060000.5 | 1415.613037 | 1 |
| HPS3 | SPHT1 | M3 | 1202.996338 | 4567.112793 | 1060000.5 | 1541.321167 | 1 |
| HPS3A | M3 | PI1 | 1188.812012 | 4567.112793 | 1850000.625 | 1531.133301 | 1 |
| HPS4 | PI1 | HPST | 1185.166626 | 4498.605957 | 1850000.625 | 1530.133179 | 1 |
| HPSD1 | SPHT3 | M3 | 1153.479126 | 5096.000977 | 130000.0469 | 1491.727783 | 1 |
| HPSSY1 | ECON4 | M3 | 1192.463745 | 5044.000977 | 660000.125 | 1522.532349 | 1 |

TABLE 14

| | | | Temperature | Pressure | Flow | Enthalpy | |
|---|---|---|---|---|---|---|---|
| Stream | From | To | Degrees F. | psia | lb/hr | btu/lb | Quality |
| HRH1 | RHT2 | PI3 | 1203.025635 | 1051.5 | 1952860.375 | 1619.046265 | 1 |
| HRH2 | PI3 | IPST | 1200.674561 | 1035.727539 | 1952860.375 | 1618.046143 | 1 |
| HS1 | ECON3 | V2 | 1061.760254 | 4731.112793 | 990000.5 | 1429.164673 | 1 |
| HTDR1 | M7 | MIXFHO | 155.4300079 | 18.80000114 | 69722.10156 | 123.4185867 | 0.0E+01 |
| HTMW10 | — | SP2 | 706.6000366 | 5000 | 70000 | 757.5561523 | 1 |
| HTMW2 | — | M2 | 354.8000183 | 5200.000977 | 40000 | 334.9745483 | 0.0E+01 |
| IPATT | SP14 | TMX4 | 175.053894 | 4802.112793 | 60449.14453 | 154.3586426 | 0.0E+01 |
| IPBFW1 | SP4 | TMX4 | 439.2961426 | 4786.113281 | 48550.85547 | 422.2418213 | 0.0E+01 |
| IPBFW2 | TMX4 | SP11 | 302.0006409 | 1100 | 109000 | 273.6793823 | 0.0E+01 |
| IPBFW3 | SP11 | — | 302.0006409 | 1100 | 95000 | 273.6793823 | 0.0E+01 |
| IPSTM1 | — | M6 | 565 | 1100 | 95000 | 1199.793945 | 1 |
| ITMA1 | — | ITMD2 | 58.99998856 | 14.43239689 | 726250 | −0.241509497 | 4 |
| ITMA2 | ITMD2 | ITMC1 | 58.99998856 | 14.32439709 | 726250 | −0.241509497 | 4 |
| ITMA3 | ITMC1 | ITMM1 | 805.5056763 | 239.9999847 | 726250 | 185.0277557 | 4 |
| ITMA4 | ITMM1 | ITMC2 | 809.6506958 | 238.5012054 | 1012249.938 | 186.1000214 | 4 |
| ITMA5 | ITMC2 | HX1 | 1131.035889 | 499.9999965 | 1012249.938 | 270.8806458 | 4 |
| LPBFW | SP11 | V1 | 302.0006409 | 1100 | 14000.00586 | 273.6793823 | 0.0E+01 |
| LPBFW2 | V1 | — | 303.5635071 | 230 | 14000.00586 | 273.6793823 | 0.0E+01 |
| MAKWAT | MAKEUP | DEAER | 80.00002289 | 2.175565243 | 571218.125 | 48.04108429 | 0.0E+01 |
| NCOOL1 | 7FBSP1 | TEX1 | 820.1157227 | 257.8391418 | 470897.8438 | 188.8095856 | 4 |
| O2CL1 | SP8 | SP12 | 88.63121796 | 5200.000977 | 1270000.125 | 70.47751617 | 0.0E+01 |
| O2CL1A | SP12 | SCOOL2 | 88.63121796 | 5200.000977 | 230000.1094 | 70.47751617 | 0.0E+01 |
| O2F1 | ECONO1 | O2C2 | 126.2008896 | 4.800000191 | 219257.1719 | 14.55714703 | 0.0E+01 |
| O2F2 | O2C2 | HX5 | 580.8051758 | 33.60000229 | 219257.1719 | 118.7049561 | 0.0E+01 |
| O2F3 | HX5 | 02C3 | 142.5836487 | 32.9280014 | 219257.1719 | 18.17884636 | 0.0E+01 |
| O2F4 | 02C3 | HX2 | 607.8831787 | 230.4960022 | 219257.1719 | 125.1657944 | 0.0E+01 |
| O2F5 | HX2 | O2C3 | 142.2881622 | 230.4960022 | 219257.1719 | 18.11273575 | 0.0E+01 |
| O2F6 | O2C3 | — | 650.9549561 | 1800 | 219257.1719 | 135.5018158 | 0.0E+01 |
| O2S11 | — | SPHTO1 | 1600 | 4.800000191 | 219257.1719 | 377.4942017 | 0.0E+01 |
| O2S12 | EVAPO2 | ECONO1 | 648.5640869 | 4.800000191 | 219257.1719 | 134.9262085 | 0.0E+01 |
| O2S12A | SPHTO1 | EVAPO2 | 1309.351807 | 4.800000191 | 219257.1719 | 301.1045837 | 0.0E+01 |
| OHPS1 | EVAPO2 | SP16 | 628.5641479 | 1900 | 57859.75 | 1145.586182 | 1 |
| OHPS1A | SP16 | SPHTO1 | 628.5641479 | 1900 | 50000 | 1145.586182 | 1 |
| OHPS1B | SP16 | M6 | 628.5641479 | 1900 | 7859.745605 | 1145.586182 | 1 |
| OHPS2 | SPHTO1 | — | 999.9943237 | 1900 | 50000 | 1477.369019 | 1 |
| OW1 | SP8 | SP13 | 88.63121796 | 5200.000977 | 147859.7813 | 70.47751617 | 0.0E+01 |
| OW1A | V3 | ECONO1 | 97.45702362 | 1900 | 57859.74609 | 70.47751617 | 0.0E+01 |
| OW1A1 | SP13 | V3 | 88.63121796 | 5200.000977 | 57859.74609 | 70.47751617 | 0.0E+01 |
| OW2 | ECONO1 | EVAPO2 | 529.2040405 | 1900 | 57859.74609 | 522.0948486 | 0.0E+01 |
| OW2A | SP13 | HX5 | 88.63121796 | 5200.000977 | 45000.01953 | 70.47751617 | 0.0E+01 |
| OW2B | HX5 | M2 | 559.3135986 | 5096.000977 | 45000.01953 | 555.4293213 | 0.0E+01 |
| OW3A | SP13 | HX2 | 88.63121796 | 5200.000977 | 45000.01953 | 70.47751617 | 0.0E+01 |

TABLE 15

| | | | Temperature | Pressure | Flow | Enthalpy | |
|---|---|---|---|---|---|---|---|
| Stream | From | To | Degrees F. | psia | lb/hr | btu/lb | Quality |
| OW3B | HX2 | M2 | 585.8498535 | 5200.000977 | 45000.01953 | 586.9161987 | 0.0E+01 |
| OW4 | M2 | ECON5 | 509.3457947 | 5096.000977 | 130000.0469 | 498.4963684 | 0.0E+01 |
| OW4A | ECON5 | V4 | 1127.886597 | 5096.000977 | 130000.0469 | 1471.739258 | 1 |
| OW4B | V4 | SPHT3 | 1127.886597 | 5096.000977 | 130000.0469 | 1471.739258 | 1 |
| S33 | AC1 | CNDPMP | 84.86373138 | 0.620000005 | 2451423 | 52.89148712 | 0.0E+01 |
| S34 | CONDST | SPLDA | 86.88021088 | 0.632653058 | 1732644 | 976.1881104 | 0.882024884 |
| STACK | ECON1 | — | 218.1628723 | 14.53119946 | 4115428 | 42.76017761 | 4 |
| SYNG1 | — | FPT1 | 99.99997711 | 1500.000122 | 579725 | 14.22437954 | 0.0E+01 |
| SYNG1B | FPT1 | GASF1 | 702.1469727 | 1500.000122 | 579725 | 233.4662628 | 0.0E+01 |
| SYNG2 | GASF1 | ECON4 | 2981.396973 | 1500.000122 | 579725 | 1171.842163 | 0.0E+01 |
| SYNG3 | ECON4 | CDLFIL | 732.2670898 | 1395.000122 | 579725 | 244.7807007 | 0.0E+01 |
| SYNG4 | CDLFIL | COSHYD | 732.2670898 | 1395.000122 | 579725 | 244.7807007 | 0.0E+01 |
| SYNG5 | COSHYD | SCOOL2 | 732.2670898 | 1395.000122 | 579725 | 244.7602844 | 0.0E+01 |
| SYNG6 | SCOOL2 | SELEX1 | 101.8156357 | 1297.350098 | 579725 | 14.87065125 | 0.0E+01 |
| SYNG7 | SELEX1 | — | 101.8156357 | 1297.350098 | 579725 | 14.87065125 | 0.0E+01 |
| WGS1 | SP12 | — | 88.63121796 | 5200.000977 | 1040000 | 70.47751617 | 0.0E+01 |
| XOVER | IPST | SP5 | 545.0579224 | 90.00000763 | 1944627 | 1302.892578 | 1 |
| XOVERB | SP5 | CONDST | 545.0579224 | 90.00000763 | 1864768.625 | 1302.892578 | 1 |

### Options

Although this high efficiency plant has been demonstrated with a state-of-the-art dry gasification system, it is not limited to any particular gasification process. Other dry feed or slurry fed gasification processes are acceptable in this plant configuration, and minor changes to the overall process to accommodate these various processes do not alter the basic configuration of this power plant.

As it was mentioned above, the gas turbine utilized in this example is the GE Frame 7FB. Although it is an engine that many consider to be the most likely candidate for IGCC power plants, there is no reason why other GT engines, either larger or smaller, or supplied by other manufacturers cannot be utilized in this power plant embodiment.

For this example, steam conditions of 4500 psia, 1200° F. inlet and 1200° F. reheat were used in the steam turbine. In the future, even higher pressures and temperatures are anticipated, and the NOVELEDGE high density combined cycle concept, with its elevation of the exhaust gas temperatures into the HRSG, allows for the production of these higher steam conditions. However, lower steam conditions may also be utilized in this embodiment as well.

The example in this embodiment illustrates the use of the HTM system for hydrogen separation. However, the concept is that many different systems for CO₂ separation can be employed while still maintaining the overall power plant structure of this embodiment.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

I claim:

1. An integrated gasification combined cycle power plant process comprising the steps of:
firing duct burners in a combined cycle power plant HRSG; and
heating an air supply within the HRSG to between 800 and 900° C. (1470 and 1650° F.), such that the air supply can be used in a membrane oxygen separation system.

2. The process of step 1, wherein the heating step heats a gas stream containing oxygen, separate from turbine exhaust gas, to between 800 and 900° C. (1470 and 1650° F.), such that the oxygen can be used in a membrane oxygen separation system.

3. The process of claim 1, further comprising the step of operating a high-density combined cycle power plant to produce steam temperature in the HRSG that is greater than the temperature of exhaust from a gas turbine of the high-density combined cycle power plant.

4. The process of claim 3, further comprising the steps of:
operating the high-density combined cycle power plant such that gas turbine exhaust temperature entering a first steam heating section of the HRSG; and
controlling feedwater flow into a low temperature section of the HRSG, such that a resulting stack temperature is between 82 and 121° C. (180 and 250° F.).

5. The process of claim 1, wherein the integrated gasification combined cycle power plant process has a syngas stream, oxygen stream, and process streams, further comprising the steps of:
providing a high-density combined cycle power plant;
recovering energy from the syngas stream, oxygen stream, and process streams; and
converting the recovered energy into high pressure steam suitable for injecting into a main inlet of a steam turbine directly or after passing through the HRSG for further heating.

6. The process of claim 1, further comprising the steps of:
recovering heat from a membrane oxygen separation process; and
preheating diluent for a gas turbine to over 204° C. (400° F.).

7. The process of claim 1, further comprising the steps of:
recovering heat from a membrane oxygen separation process; and
preheating at least one of syngas and hydrogen for a gas turbine to over 204° C. (400° F.).

8. The process of claim 1, further comprising the step of:
compressing an oxygen stream resulting in heat; and
preheating syngas with the heat of compressing the oxygen stream.

9. The process of claim 1, further comprising the steps of:
extracting steam from a steam turbine; and
drying and preheating coal before introducing the coal to a gasifier.

10. The process of claim 1, further comprising the steps of:
providing an expander to expand syngas to a desired fuel pressure for a gas turbine; and
generating power from the expander.

11. The process of claim 1, further comprising the steps of:
providing an expander to expand syngas to a desired fuel pressure for a duct burner; and
generating power from the expander.

12. The process of claim 1, further comprising the steps of:
extracting steam from a steam turbine; and
providing the steam for gasification process and heating requirements.

13. The process of claim 1, further comprising the step of providing a progressive series syngas heating and water injection to moisturize syngas above its dewpoint.

14. The process of claim 1, further comprising the step of burning at least 10% of its fuel in low pressure duct burners in the HRSG, thereby reducing the need for hydrogen compression to the higher pressures needed by a gas turbine.

15. The process of claim 1, further comprising the steps of:
providing a heat recovery device for recovering energy from a water-gas shift reaction; and thereby providing energy for
moisturizing syngas.

16. The process of claim 1, further comprising the steps of:
providing a heat recovery device for recovering energy from a water-gas shift reaction; and thereby providing energy for
preheating high pressure feedwater to a power island.

17. The process of claim 1, further comprising the steps of:
cooling raw syngas to 38° C. (100° F.) for processing in a clean-up process; and
reheating the syngas with a gas stream from an ITM oxygen process.

18. An integrated gasification combined cycle power plant process comprising the steps of:
firing duct burners in a combined cycle power plant HRSG; and
heating an air supply within the HRSG to between 800 and 900° C. (1470 and 1650° F.), such that the air supply can be used in a membrane oxygen separation system.

19. An integrated gasification combined cycle power plant device comprising:
an HRSG duct burner adapted to heat an air supply to between 800 and 900° C. (1470 and 1650° F.); coupled with
a membrane oxygen separation system.

20. The device of claim 19 further comprising an energy recovery device that recovers energy from the heated air supply and converts the energy into high-pressure steam for injecting into a main inlet of a steam turbine directly or after passing through the HRSG for further heating.

21. The device of claim 19 wherein the duct burner is a multiple heating section duct burner adapted to provide different downstream temperatures in different sections.

22. The device of claim 19 further comprising a cold gas clean up system designed to that a water-gas shift reaction occurs downstream of the cold gas clean up system.

23. The device of claim 19 further comprising:
a cold gas clean up system; and
a hydrogen transport membrane system is coupled downstream of the cold gas clean up system.
